(19) United States
(12) Patent Application Publication
(10) Pub. No.: US 2023/0141005 A1
(43) Pub. Date: May 11, 2023

(54) IMAGE PROCESSING APPARATUS AND METHOD

(71) Applicant: SONY GROUP CORPORATION, Tokyo (JP)

(72) Inventors: Yusuke MORIUCHI, Kanagawa (JP); Kenichiro NAKAMURA, Saitama (JP); Hajime MIHARA, Tokyo (JP); Takayuki SASAKI, Tokyo (JP)

(73) Assignee: SONY GROUP CORPORATION, Tokyo (JP)

(21) Appl. No.: 17/918,500

(22) PCT Filed: May 14, 2021
(86) PCT No.: PCT/JP2021/018356

§ 371 Date: Oct. 12, 2022

(30) Foreign Application Priority Data
May 29, 2020 (JP) 2020-093822

(51) Int. Cl. G06V 10/762; G06T 3/40

(52) U.S. Cl. CPC G06V 10/762; G06T 3/4007; G06T 3/4038

(57) ABSTRACT

There is provided an image processing apparatus and method capable of suppressing an increase in a processing time for image clustering. Sparse pixels included in an image are clustered, sparse information obtained by this clustering is interpolated by image filtering that uses an image signal as a guide, and thereby a dense clustering result is derived. For example, the sparse information is model coefficients or a clustering result obtained by the clustering. The present disclosure can be applied to, for example, an image processing apparatus, an image processing method, and the like.

### TECHNICAL FIELD

The present disclosure relates to an image processing apparatus and method, and, more particularly, to an image processing apparatus and method capable of suppressing an increase in a processing time for image clustering.

### BACKGROUND ART

Conventionally, image clustering has been used for various image processing (see, for example, Patent Document 1). For example, Patent Document 1 discloses a method of clustering an image, interpolating pixels by using class data of the image, and restoring thinned pixels.

### CITATION LIST

### Patent Document

Patent Document 1: Japanese Patent Application Laid-Open No. 5-328185

### SUMMARY OF THE INVENTION

### Problems to be Solved by the Invention

However, according to clustering of a conventional method, all pixels of a processing target image are clustered, and therefore a processing time is concerned to increase.

The present disclosure has been made in view of such a situation, and makes it possible to suppress an increase in a processing time of image clustering.

### Solutions to Problems

An image processing apparatus according to one aspect of the present technology is an image processing apparatus that includes: a clustering unit configured to cluster a sparse pixel included in an image; and an interpolation processing unit configured to interpolate sparse information by image filtering, and thereby derive a dense clustering result, the sparse information being obtained by the clustering of the clustering unit, and the image filtering using an image signal as a guide.

An image processing method according to one aspect of the present technology is an image processing method that includes: clustering a sparse pixel included in an image; and interpolating sparse information by image filtering, and thereby deriving a dense clustering result, the sparse information being obtained by the clustering, and the image filtering using an image signal as a guide.

An image processing apparatus according to another aspect of the present technology is an image processing apparatus that includes a clustering unit configured to perform local clustering by using information, the local clustering being clustering of a dense pixel included in a local area of an image, and the information being obtained by wide area clustering that is clustering of a sparse pixel included in a wide area of the image.

An image processing method according to another aspect of the present technology is an image processing method that includes performing local clustering by using information, the local clustering being clustering of a dense pixel included in a local area of an image, and the information being obtained by wide area clustering that is clustering of a sparse pixel included in a wide area of the image.

The image processing apparatus and method according to the one aspect of the present technology cluster sparse pixels included in an image, interpolate sparse information obtained by this clustering by image filtering that uses an image signal as a guide, and thereby derive a dense clustering result.

The image processing apparatus and method according to the another aspect of the present technology perform local clustering that is clustering of dense pixels included in a local area of an image, by using information obtained by wide area clustering that is clustering of sparse pixels included in a wide area of the image.

### BRIEF DESCRIPTION OF DRAWINGS

FIG. 1 is a block diagram illustrating a main configuration example of an image processing apparatus.

FIG. 2 is a view for explaining an example of how image filtering is performed.

FIG. 3 is a view for explaining an example of sparse model coefficients.

FIG. 4 is a view for explaining an example of a guide.

FIG. 5 is a view for explaining an example of dense model coefficients.

FIG. 6 is a view for explaining an example of a clustering result.

FIG. 7 is a flowchart for explaining an example of a flow of clustering processing.

FIG. 8 is a block diagram illustrating a main configuration example of an image processing apparatus.

FIG. 9 is a view for explaining an example of a field.

FIG. 10 is a flowchart for explaining an example of a flow of clustering processing.

FIG. 11 is a block diagram illustrating a main configuration example of an image processing apparatus.

FIG. 12 is a view for explaining an example of stitching information.

FIG. 13 is a flowchart for explaining an example of a flow of clustering processing.

FIG. 14 is a block diagram illustrating a main configuration example of an image processing apparatus.

FIG. 15 is a flowchart for explaining an example of a flow of clustering processing.

FIG. 16 is a view for explaining an example of an outline of image clustering.

FIG. 17 is a block diagram illustrating a main configuration example of an image processing apparatus.

FIG. 18 is a flowchart for explaining an example of a flow of clustering processing.

FIG. 19 is a block diagram illustrating a main configuration example of an image processing apparatus.

FIG. 20 is a flowchart for explaining an example of a flow of clustering processing.

FIG. 21 is a block diagram illustrating a main configuration example of an image processing apparatus.

FIG. 22 is a view for explaining an example of how clustering results are compared.

FIG. 23 is a flowchart for explaining an example of a flow of clustering processing.

FIG. 24 is a block diagram illustrating a main configuration example of an image processing apparatus.

FIG. 25 is a flowchart for explaining an example of a flow of clustering processing.

FIG. 26 is a block diagram illustrating a main configuration example of an image processing apparatus.

FIG. 27 is a flowchart for explaining an example of a flow of clustering processing.

FIG. 28 is a view for explaining an example of how CT images are generated.

FIG. 29 is a view for explaining an example of how CT images illustrating an example of a global area and a local area are generated.

FIG. 30 is a block diagram illustrating a main configuration example of an image processing apparatus.

FIG. 31 is a flowchart for explaining an example of a flow of clustering processing.

FIG. 32 is a block diagram illustrating a main configuration example of a computer.

### MODE FOR CARRYING OUT THE INVENTION

Hereinafter, modes for carrying out the present disclosure (hereinafter referred to as embodiments) will be described. Note that the description will be given in the following order.

1. First Embodiment (Sparse Clustering and Image Filtering)

2. Second Embodiment (Wide Area Clustering and Sparse Local Clustering)

3. Third Embodiment (Wide Area Clustering and Dense Local Clustering)

4. Fourth embodiment (Clustering in Vegetation Area Analysis)

5. Fifth embodiment (Clustering of CT Images)

6. Supplementary Note

### 1. First Embodiment

<Image Clustering>

Conventionally, image clustering has been used for various image processing. For example, Patent Document 1 discloses a method of clustering an image, interpolating pixels by using class data of the image, and restoring thinned pixels.

Furthermore, in a case where, for example, a so-called drone, an airplane, or the like images a field a plurality of times from the sky while moving, and vegetation is analyzed (vegetation and soil are classified or the like) by using this captured image, image clustering is used.

However, according to clustering of the conventional method, all pixels of a processing target image are clustered, and therefore a processing time is concerned to increase.

<Sparse Clustering and Image Filtering>

Hence, sparse pixels included in an image are clustered, sparse information obtained by this clustering is interpolated by image filtering that uses an image signal as a guide, and thereby a dense clustering result is derived. The information for which this image filtering is performed may be, for example, model coefficients of learning, a clustering result, or the like. “Interpolation” by this image filtering means not only interpolation of information (filling of missing data), but also optimization or the like according to an image structure as appropriate. That is, an optimized dense clustering result is obtained by this image filtering.

In a case of, for example, a captured image of a field, imaging is performed in an outdoor environment, and therefore there is a probability that lighting environment changes significantly during an imaging work, and a cast shadow, a shading, or the like causes unevenness in a signal distribution in the same subject (a plurality of pixels of the same subject has different signal characteristics). Even in such a case, by performing clustering as described above, it is possible to obtain a clustering result that uses image structure information of surroundings at a high speed. That is, by applying the present technology, it is possible to reflect, in the clustering result, regularization that matches a geometric structure of a guide image, so that it is possible to obtain a result classified per subject even from an image showing a significant change in lighting environment outdoors or an image having unevenness in a signal distribution in the same subject due to a cast shadow or a shading.

<Image Processing Apparatus>

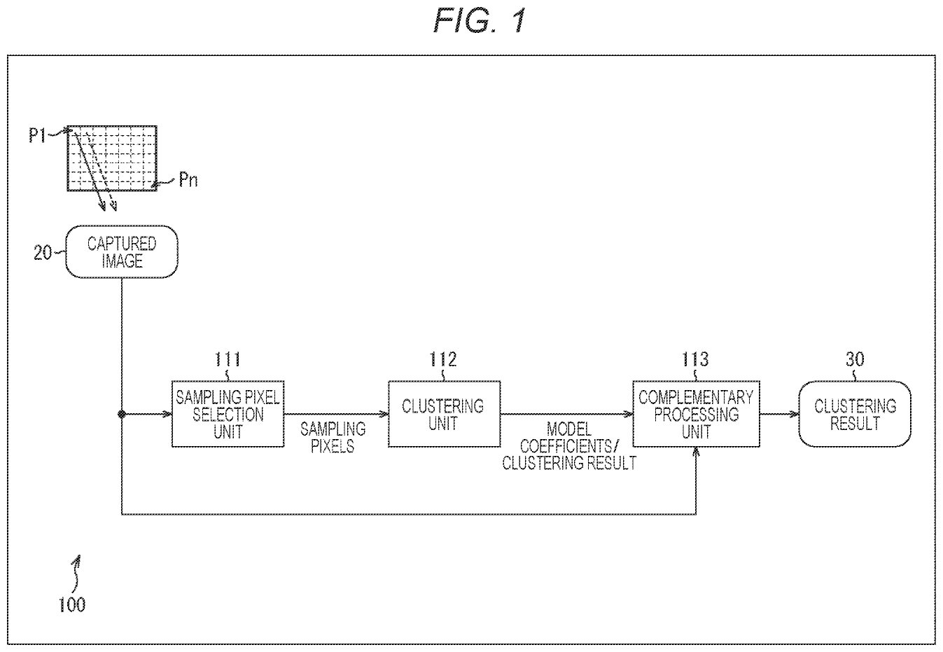

FIG. 1 is a block diagram illustrating an example of a configuration of an image processing apparatus to which the present technology is applied. An image processing apparatus 100 illustrated in FIG. 1 is an apparatus that performs image clustering. The image processing apparatus 100 receives a captured image 20 as input, performs the image clustering on this captured image 20, and outputs a clustering result 30 of this image clustering.

The captured image 20 may be, for example, a stitching image obtained by stitching a plurality of captured images (P1 to Pn). Furthermore, the captured image 20 may be a moving image including a plurality of frame images. Furthermore, the captured image 20 may be a file (captured image group) obtained by integrating a plurality of captured images into one, or may be one captured image. Naturally, the captured image 20 may be an image other than a captured image (e.g., a CG image or the like). Furthermore, this captured image 20 may be an image of a wavelength range of visible light (RGB), or may be an image obtained by imaging a wavelength range of invisible light such as near-infrared light. Furthermore, the captured image 20 may be both of these images.

Note that FIG. 1 illustrates main elements such as processing units and data flows, and the elements illustrated in FIG. 1 are not necessarily all. That is, in this image processing apparatus 100, there may be a processing unit that is not illustrated as a block in FIG. 1, or there may be processing or a data flow that is not illustrated as an arrow or the like in FIG. 1.

As illustrated in FIG. 1, the image processing apparatus 100 includes a sampling pixel selection unit 111, a clustering unit 112, and an interpolation processing unit 113.

The sampling pixel selection unit 111 performs processing related to selection of sampling pixels that are clustering target pixels. For example, the sampling pixel selection unit 111 obtains the captured image 20. Furthermore, the sampling pixel selection unit 111 selects part of pixels of this captured image 20 as sampling pixels. In this case, the sampling pixel selection unit 111 selects the sampling pixels such that the sampling pixels are in a sparse state.

The “sparse state” refers to a state of a pixel group (or information corresponding to this pixel group) including part of pixels of a captured image, and refers to at least a state of a pixel group (or information corresponding to this pixel group) including a smaller number of pixels than that of a “dense state” described later. For example, a pixel group (or information corresponding to this pixel group) including pixels having a positional relationship that the pixels are not adjacent to each other may be in the “sparse state”. That is, in a case of sampling pixels, the sampling pixels selected from only pixels having the positional relationship that the pixels are not adjacent to each other in the captured image 20 may be sampling pixels in the sparse state (also referred to as sparse sampling pixels). Furthermore, a pixel group (or information corresponding to this pixel group) selected from a predetermined image at a rate (number) smaller than a predetermined threshold may be in the “sparse state”. That is, in a case of sampling pixels, sampling pixels selected at the rate (number) smaller than the predetermined threshold with respect to the number of pixels of the captured image 20 may be the sparse sampling pixels.

The sampling pixel selection unit 111 supplies the selected sparse sampling pixels to the clustering unit 112.

The clustering unit 112 performs processing related to clustering. For example, the clustering unit 112 obtains the sparse sampling pixels supplied from the sampling pixel selection unit 111. The clustering unit 112 clusters these obtained sparse sampling pixels as processing targets. This clustering method is arbitrary. For example, a GMM, a k-means method, or the like may be applied. The clustering unit 112 supplies sparse information obtained by this clustering to the interpolation processing unit 113.

This sparse information is information that is obtained by clustering the sparse sampling pixels, and corresponds to each sampling pixel (i.e., a sparse state). For example, the sparse information may be model coefficients of learning, may be a clustering result, or may be both of the model coefficients of learning and the clustering result.

The interpolation processing unit 113 performs processing related to interpolation of the sparse information. For example, the interpolation processing unit 113 obtains the sparse information (the model coefficients of learning, the clustering result, or the like) supplied from the clustering unit 112. Furthermore, the interpolation processing unit 113 obtains the captured image 20.

This captured image 20 may be the same as the captured image (i.e., the captured image to be clustered) supplied to the sampling pixel selection unit 111, or may be a captured image whose time and range are substantially the same time and substantially the same range as those of the captured image to be clustered, and that is different from this captured image to be clustered. For example, the captured image 20 may be another captured image obtained by another imaging at substantially the same time and at substantially the same angle of view as imaging for obtaining the captured image to be clustered. For example, the captured image 20 of the wavelength range of visible light (RGB) may be supplied to the sampling pixel selection unit 111, and the captured image 20 obtained by imaging the wavelength range of invisible light such as near-infrared ray may be supplied to the interpolation processing unit 113.

The interpolation processing unit 113 performs image filtering (interpolation processing) on the sparse information obtained from the clustering unit 112 by using an image signal (obtained captured image 20) as a guide, and derives a clustering result of a dense state.

The “dense state” refers to a state of a pixel group (or information corresponding to this pixel group) including part or all of pixels of a captured image, and refers to at least a state of a pixel group (or information corresponding to this pixel group) including a larger number of pixels than that of the above-described “dense state”. For example, a pixel group (or information corresponding to this pixel group) including pixels, too, having a positional relationship that the pixels are adjacent to each other may be in the “dense state”. That is, in a case of a clustering result, the clustering result of the sampling pixels including pixels, too, having the positional relationship that the pixels are adjacent to each other in captured image 20 may be the dense state (also referred to as dense clustering result). Furthermore, a pixel group (or information corresponding to this pixel group) selected from a predetermined image at a rate (number) equal to or more than a predetermined threshold may be in the “dense state”. That is, in a case of a clustering result, the clustering result of sampling pixels selected at the rate (number) equal to or more than the predetermined threshold with respect to the number of pixels of the captured image 20 may be the dense clustering result.

For example, the interpolation processing unit 113 receives a likelihood (likelihood image) of each pixel for each class as an input, sequentially applies image filtering that uses the original image as a guide to perform interpolation, redetermines the class from this filtered likelihood image, and thereby acquires a dense clustering result. The image filtering can reflect, in the clustering result, regularization that matches a geometric structure of the guide image, so that the interpolation processing unit 113 can obtain a result classified per subject even from an image showing a significant change in lighting environment outdoors or an image showing unevenness in a signal distribution in the same subject due to a cast shadow or a shading. For example, it is possible to suppress occurrence of a phenomenon that part of a portion of the same color of the same subject becomes a shade and is classified into another class due to a difference in brightness.

The interpolation processing unit 113 outputs the clustering result 30 (dense clustering result) obtained by this interpolation processing as an image processing result of the image processing apparatus 100 to an outside of the image processing apparatus 100.

<Image Filtering>

A method of this image filtering (interpolate processing) is arbitrary. By using edge-preserving filtering that operates at a high speed, such as Fast Global Smother filtering, Domain Transform filtering, Fast Bilateral Solver filtering, or Domain Transform Solver filtering as the image filtering, it is possible to obtain a clustering result that is robust against noise and disturbance influences at a higher speed than prediction in all pixels.

For example, the interpolation processing unit 113 may perform energy minimization of a clustering result by GrabCut disclosed in Jianbo Li, et. al, “KM_GrabCut: a fast interactive image segmentation algorithm”, ICGIP 2014. (also referred to as Non-Patent Document 1), perform wide area optimization by Cost-Volume Filtering disclosed in C. Rhemann, et. al, “Fast Cost-Volume Filtering for Visual Correspondence and Beyond”, CVPR 2011. (also referred to as Non-Patent Document 2), use an FGS filter disclosed in D. Min. et. al, “Fast Global Image Smoothing Based on Weighted Least Squares”, IEEE TIP 2014. (also referred to as Non-Patent Document 3), and highly densify information.

The fast global weighted least squares filter (FGWLS) disclosed in Non-Patent Document 3 is processing of decomposing a weighted least squares filter (WLS) disclosed in Z Farbman, et Al., “Edge-Preserving Decompositions for Multi-Scale Tone and Detail Manipulation,” Proceedings of ACM SIGGRAPH 2008. (also referred to as Non-Patent Document 4) into a one-dimensional recursive filter, repeatedly applying the one-dimensional recursive filter in x and y axis directions, and thereby obtaining an overall optimal solution by a constant time operation. By this processing, sparse data is expanded and highly densified according to an image structure of a texture, an edge or the like (according to an adjacent relationship between pixels obtained on the basis of this structure).

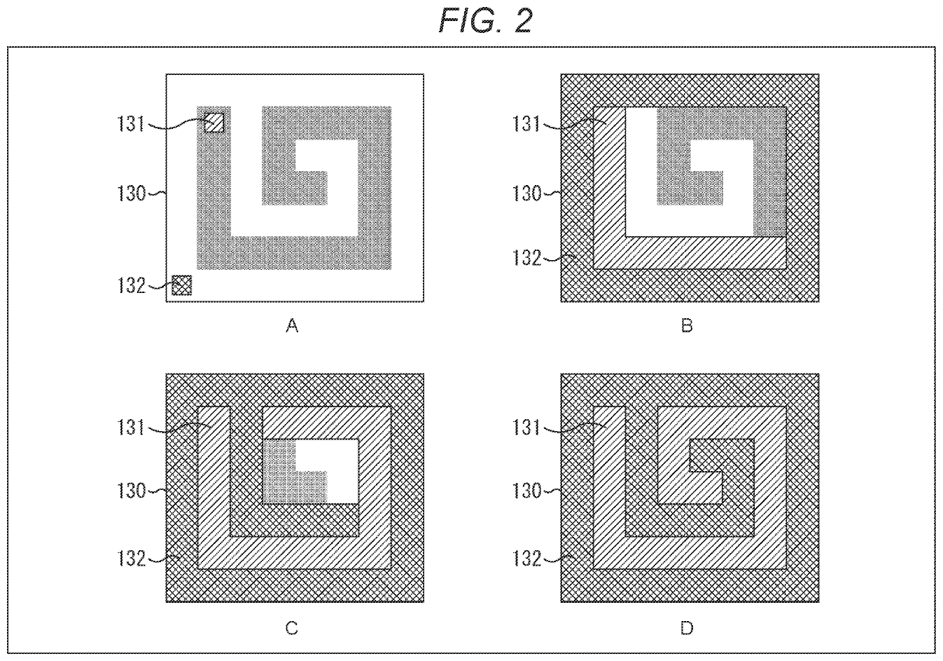

By using, for example, an image 130 including a gray and white spiral picture pattern as a guide as illustrated in A of FIG. 2, the above-described image filtering is performed on pixels in an area 131 of a first color indicated by a diagonal line pattern and pixels in an area 132 of a second color indicated by a mesh pattern. The area 131 of the first color is located in a gray area of the image 130. The area 132 of the second color is located in a white area of the image 130.

By repeatedly performing a linear recursive operation of adjacent pixels in the x and y directions, the area 131 of the first color is enlarged in the gray area of the image 130 as illustrated in B of FIG. 2, C of FIG. 2, and D of FIG. 2. Similarly, the area 132 of the second color is enlarged in the white area of the image 130. Then, in the state in D of FIG. 2, an area on the image 130 is filled with the area 131 of the first color and the area 132 of the second color. That is, the area 131 of the first color and the area 132 of the second color that are in the sparse state in A of FIG. 2 (that are sparse portions in the area on the image 130) are in the dense state in D of FIG. 2 (a state where the areas on the image 130 are filled).

In this way, by performing the image filtering, it is possible to interpolate and highly densify sparse data according to a structure of an image used as a guide. Consequently, the image processing apparatus 100 can obtain a more accurate clustering result. Note that, as described above, “interpolation” by this filtering means not only interpolation of information (filling of missing data), but also optimization or the like according to an image structure as appropriate. That is, an optimized dense clustering result is obtained by this image filtering. Consequently, the image processing apparatus 100 can obtain a more accurate clustering result.

In addition to the above examples, as the image filtering, rule-based filtering disclosed in Eduardo S L Gastal and Manuel M Oliveira, “Domain transform for edge-aware image and video processing”, In ACM Transactions on Graphics (TOG), volume 30, page 69. ACM, 2011. (also referred to as Non-Patent Document 5), Jonathan T Barron and Ben Poole, “The Fast Bilateral Solver”, In European Conference on Computer Vision (ECCV), pages 617-632. Springer International Publishing, 2016. (also referred to as Non-Patent Document 6), and Akash Bapat, Jan-Michael Frahm, “The Domain Transform Solver”, The IEEE Conference on Computer Vision and Pattern Recognition (CVPR), 2019, pp. 6014-6023. (also referred to as Non-Patent Document 7), and the like may be applied. Furthermore, deep learning (Deep Neural Network (DNN))-based filtering disclosed in Hang Su, Varun Jampani, Deqing Sun, Orazio Gallo, Erik Learned-Miller, Jan Kautz, “Pixel-Adaptive Convolutional Neural Networks”, Proceedings of the IEEE Conference on Computer Vision and Pattern Recognition (CVPR), 2019. (also referred to as Non-Patent Document 8), Yu-Kai Huang, Tsung-Han Wu, Yueh-Cheng Liu, Winston H. Hsu, “Indoor depth completion with Boundary Consistency and Self-Attention”, (ICCV), 2019. (also referred to as Non-Patent Document 9), and Jie Tang, Fei-Peng Tian, Wei Feng, Jian Li, Ping Tan, “Learning Guided Convolutional Network for Depth Completion”, arXiv preprint arXiv: 1908.01238, 2019. (also referred to as Non-Patent Document 10), and the like may be applied.

The clustering unit 112 performs clustering as described above, and supplies the sparse information (the model coefficients, the clustering result, or the like) to the interpolation processing unit 113.

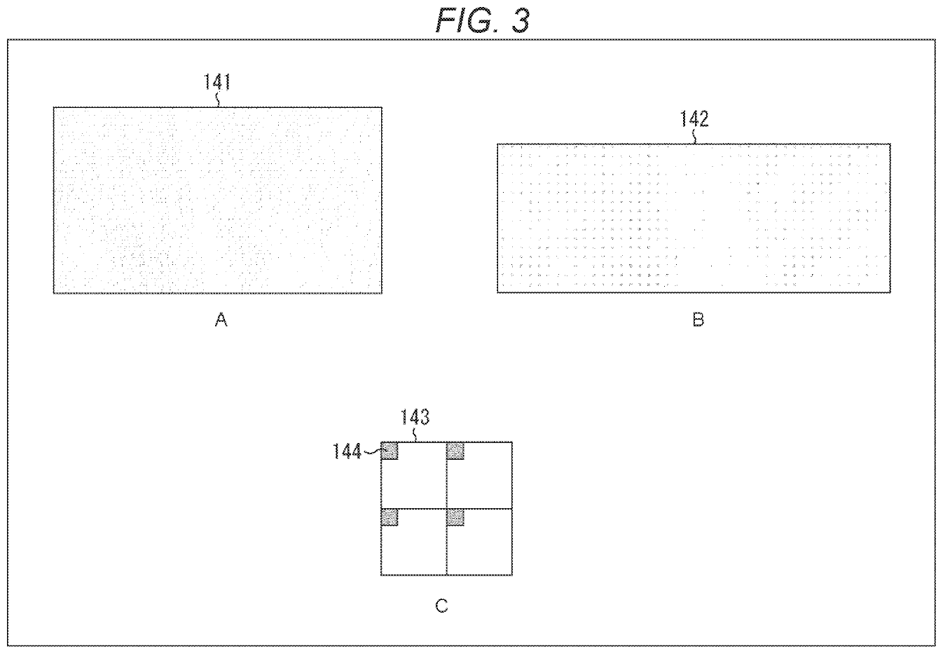

FIG. 3 is a diagram illustrating an example of a result obtained by visualizing part of model coefficients. For example, a sparse model coefficient 141 illustrated in A of FIG. 3 is supplied to the interpolation processing unit 113 from the clustering unit 112. A model coefficient 142 in B of FIG. 3 is a model coefficient obtained by enlarging part of the model coefficient 141 in A of FIG. 3. A gray point group indicated in the model coefficient 142 indicates model coefficients of pixels at respective positions. Thus, the model coefficient 141 includes the sparse information (model coefficients of part of pixels).

C of FIG. 3 is a diagram schematically illustrating a structure of this sparse model coefficient 141. In C of FIG. 3, squares indicated by gray indicate pixels in which model coefficients exist. As illustrated in this example, the model coefficient 141 includes a model coefficient 144 for one pixel provided per area 143 of a predetermined size. When, for example, the area 143 is 4×4 pixels, a data amount of the model coefficient 141 is 1/16 of that in the dense case (model coefficients of all pixels).

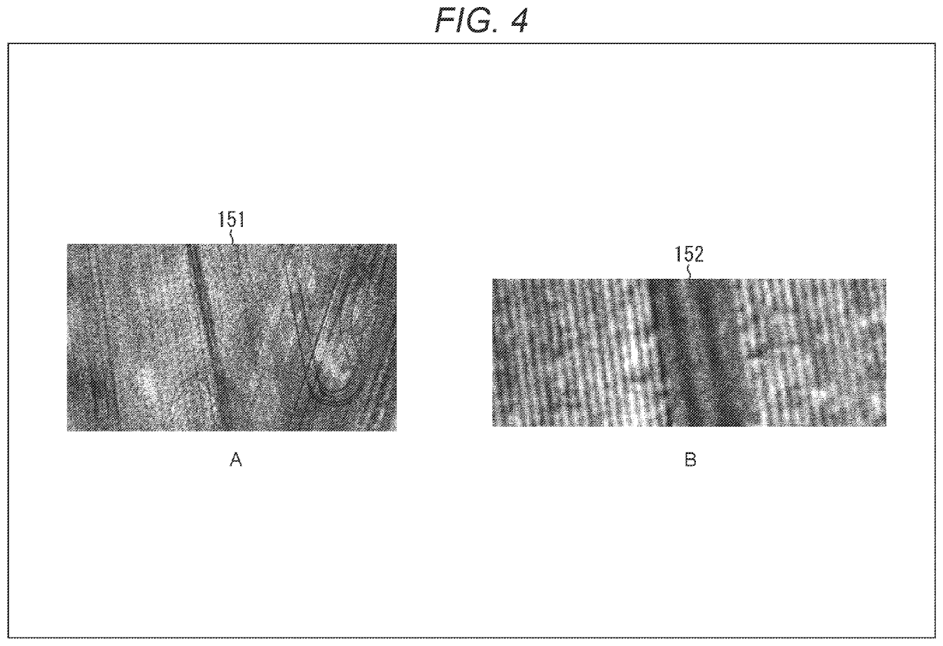

The interpolation processing unit 113 performs image filtering on this sparse model coefficient 141 by using an image signal as a guide. FIG. 4 is a diagram illustrating an example of part of an image used as this guide. For example, the interpolation processing unit 113 performs image filtering on the sparse model coefficient 141 by using an image 151 (A of FIG. 4) included in the captured image 20 as a guide. An image 152 illustrated in B of FIG. 4 is an image obtained by enlarging part of the image 151.

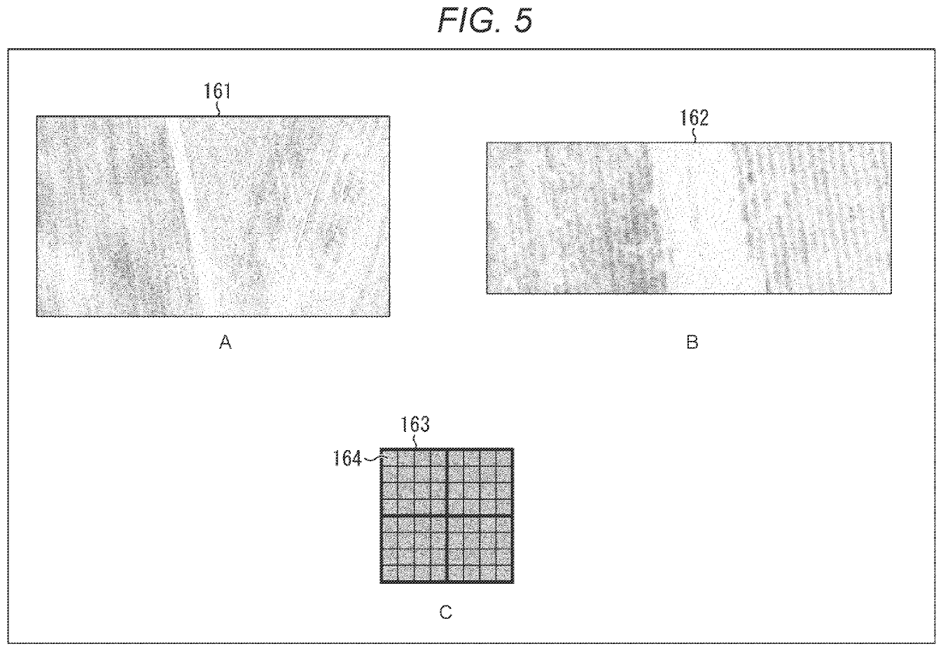

FIG. 5 is a diagram illustrating an example of a result obtained by visualizing part of model coefficients obtained by this image filtering. By, for example, image filtering of the interpolation processing unit 113, a model coefficient 161 illustrated in A of FIG. 5 is obtained. A model coefficient 162 illustrated in B of FIG. 5 is a model coefficient obtained by enlarging part of the model coefficient 161. As is clear from comparison with the model coefficient 142 (B of FIG. 3), the model coefficient 162 (i.e., the model coefficient 161) is in a dense state.

C of FIG. 5 is a diagram schematically illustrating a structure of this model coefficient 161. In C of FIG. 5, squares indicated by gray indicate pixels in which model coefficients exist. That is, in a case of this example, the model coefficient 161 includes model coefficients of all pixels. When, for example, an area 163 is 4×4 pixels, there are model coefficients 164 for 16 pixels in each area 163. Therefore, a data amount of the model coefficient 161 (A of FIG. 5) is 16 times as large as a data amount of the model coefficients 141 (A of FIG. 3).

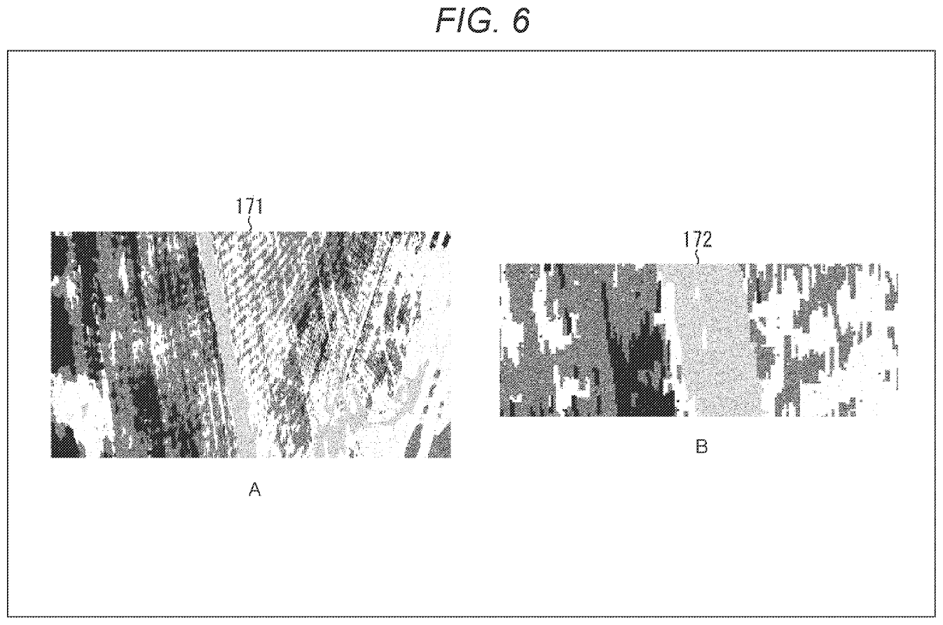

A clustering result 171 illustrated in A of FIG. 6 illustrates an example of a clustering result derived by using this dense model coefficient 161. A clustering result 172 illustrated in B of FIG. 6 is a clustering result obtained by enlarging part of the clustering result 171. In this way, by performing the image filtering, a dense clustering result is obtained from sparse model coefficients.

In, for example, a case of the structural examples in C of FIG. 3 and C of FIG. 5, although a processing time of clustering for obtaining the sparse model coefficient 141 is different depending on a method used for clustering, even in, for example, a case of a simple k-means method, an order O of a calculation amount is O=(Nk) when the number of items of data is N and the number of times of iterations is a constant k, and the processing time is approximately 1/16 of the clustering processing time for obtaining the dense model coefficient 161. When a processing time of the image filtering is taken into consideration, the entire processing time is approximately ⅓ to ¼ of a processing time in a case where the dense model coefficient 161 is obtained by clustering. That is, by applying sparse clustering and image filtering as described above, the image processing apparatus 100 can obtain a dense clustering result at a higher speed. That is, it is possible to suppress an increase in a processing time.

<Flow of Clustering Processing>

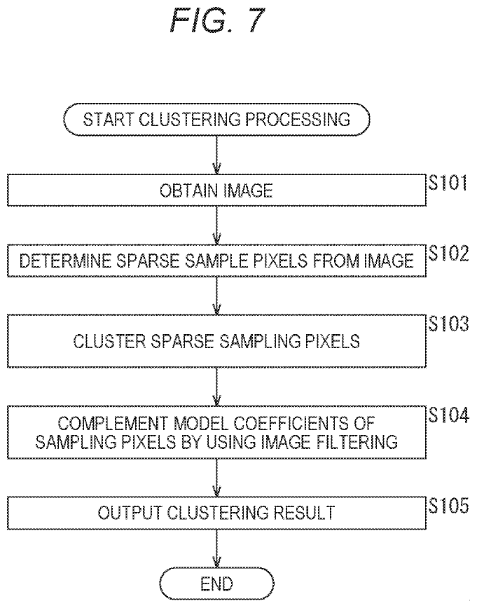

An example of a flow of the clustering processing executed by such an image processing apparatus 1000 will be described with reference to a flowchart of FIG. 7. When the clustering processing is started, the sampling pixel selection unit 111 obtains the captured image 20 in step S101.

In step S102, the sampling pixel selection unit 111 selects and determines sparse sampling pixels from the captured image obtained in step S101.

In step S103, the clustering unit 112 clusters the sparse sampling pixels determined in step S102.

In step S104, the interpolation processing unit 113 obtains the captured image 20, performs image filtering on sparse information (model coefficients of learning and a clustering result) obtained by the processing in step S103 by using this captured image 20 as a guide, interpolates this sparse information, and derives a dense clustering result.

In step S105, the interpolation processing unit 113 outputs the dense clustering result obtained by the processing in step S104 as the clustering result 30. When the processing in step S105 ends, the clustering processing ends.

By performing each processing as described above, the image processing apparatus 100 can suppress an increase in a processing time of the image clustering.

<Use of Field Information>

For example, there is a method of, when analyzing vegetation (classification of vegetation, soil and the like) targeting at a field, clustering a stitching image obtained by stitching a plurality of captured images obtained by imaging this field from the sky. In such a case, it is unnecessary to cluster an area other than this field in the area included in the stitching image. However, in general, it is difficult to perform control to perform imaging focusing on a range of the field and not image an outside of the field, and the stitching image obtained by stitching the captured images includes areas outside the field, too. Hence, when the entire stitching image is clustered as a target, an area outside the field is also clustered, and therefore unnecessary processing is likely to increase a processing time unnecessarily.

Then, only pixels in the field are selected as sampling pixels (that is, pixels in an area outside the field are not selected as the sampling pixels). Field information (field boundary information) is information regarding a field, and is, for example, information that indicates a range of the field that is a target area on which image clustering is performed. Therefore, an area of the field included in the captured image is specified by using such field information, and the sampling pixels are selected only in this specified field. By so doing, it is possible to suppress an increase in unnecessary clustering, and suppress an increase in an unnecessary processing time.

<Image Processing Apparatus>

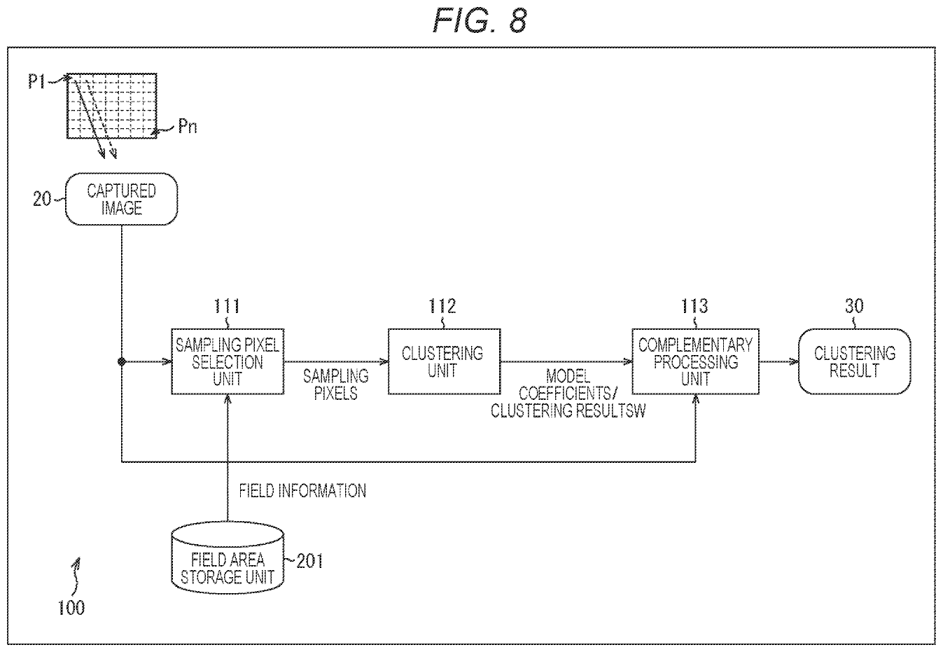

FIG. 8 is a block diagram illustrating a main configuration example of the image processing apparatus 100 in this case. The captured image 20 is a stitching image obtained by stitching a plurality of captured images obtained by imaging a clustering processing target field from the sky. As illustrated in FIG. 8, in this case, the image processing apparatus 100 includes a field area storage unit 201 in addition to the components illustrated in FIG. 1.

The field area storage unit 201 includes a storage medium, and stores information indicating an area (field area) of the processing target field in (the storage area of) this storage medium. This information indicating the field area may be any information. This information may be, for example, information that indicates a field area by using coordinate information (also referred to as GPS coordinate information) based on a global positioning system (GPS) or the like, information indicating which pixel of the captured image 20 is in the field area, or information other than these pieces of information.

The field area storage unit 201 supplies to the sampling pixel selection unit 111 information that is stored in (the storage area of) the storage medium of the field area storage unit 201 and indicates the field area as field information in response to, for example, a request of the sampling pixel selection unit 111.

The sampling pixel selection unit 111 obtains this field information, and specifies the field area included in the captured image 20 on the basis of this field information. In a case of, for example, the field information indicating the field area by using the GPS coordinate information, the sampling pixel selection unit 111 compares and checks this field information and the GPS coordinate information indicating an imaging range of this captured image 20 included in the metadata of the captured image or the like, and thereby specifies pixels corresponding to the inside of the field area of the captured image 20.

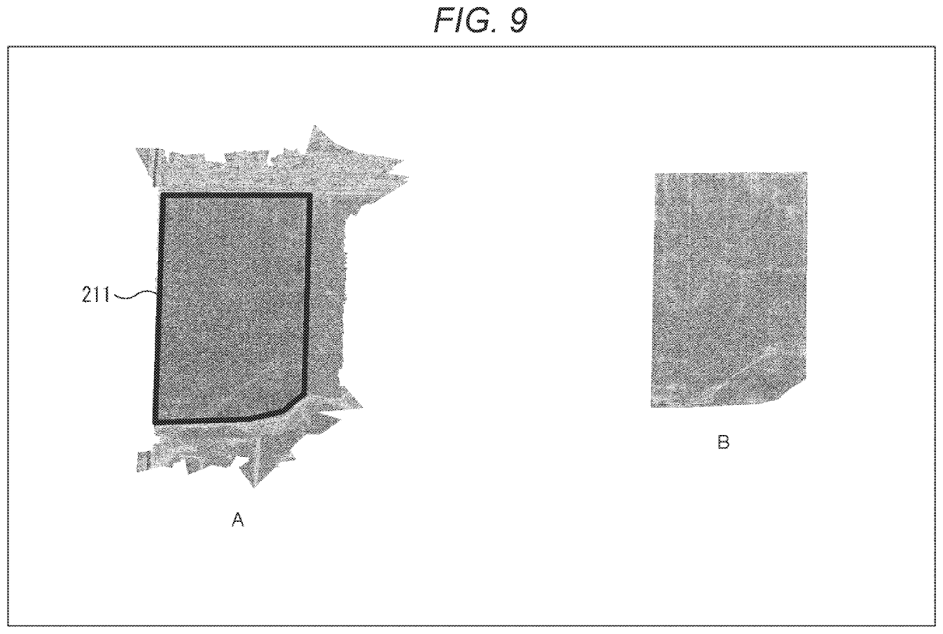

For example, a field area 211 that is part of the captured image as illustrated in A of FIG. 9 is a processing target. The field area storage unit 201 stores information that indicates this field area 211, and supplies this field information to the sampling pixel selection unit 111. As illustrated in B of FIG. 9, the sampling pixel selection unit 111 selects sampling pixels in this field area 211 on the basis of this field information, and omits selection of the sampling pixels in an area other than the field area 211.

In this case, too, a method of selecting the sampling pixels is similar to that in the case in FIG. 1. That is, the sampling pixel selection unit 111 selects sparse sampling pixels in the field area 211 indicated by the field information, and supplies the sparse sampling pixels to the clustering unit 112.

By doing so, the sampling pixels that are processing targets of the clustering unit 112 include only the pixels in the field area. That is, the clustering unit 112 and the interpolation processing unit 113 can exclude pixels outside the field area from the processing targets. Consequently, the image processing apparatus 100 can suppress an increase in unnecessary clustering, and suppress an increase in an unnecessary processing time.

<Flow of Clustering Processing>

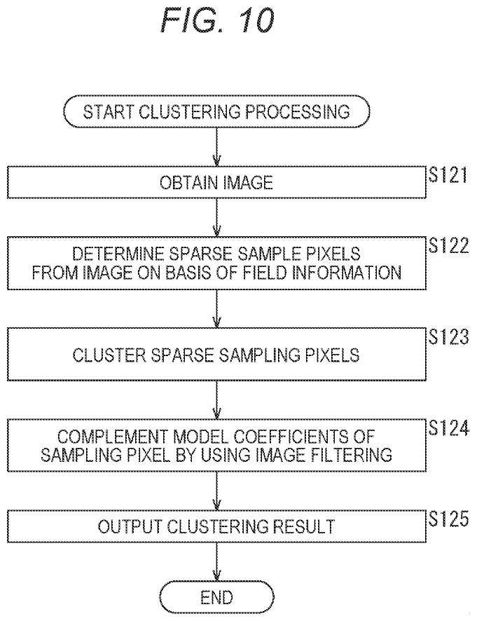

An example of a flow of the clustering processing in this case will be described with reference to a flowchart of FIG. 10. When the clustering processing is started, the sampling pixel selection unit 111 obtains the captured image 20 in step S121. Furthermore, the sampling pixel selection unit 111 obtains field information from the field area storage unit 201.

In step S122, the sampling pixel selection unit 111 selects and determines sparse sampling pixels from the field area included in the captured image obtained in step S121 on the basis of this field information.

Each processing in step S123 to step S125 is executed similar to each processing in step S103 to step S105 (FIG. 7). When the processing in step S125 ends, the clustering processing ends.

By performing each processing as described above, the image processing apparatus 100 can suppress an increase in a processing time of the image clustering.

<Use of Stitching Information>

In a case where, for example, a plurality of captured images obtained by imaging part of a field is stitched to generate a stitching image including the entire field as described above, the areas of each captured image generally include portions that are superimposed on each other. In other words, in general, it is difficult to control imaging such that the areas of each captured image are not superimposed on each other.

If sampling pixels are independently selected in each captured image, pixels in an area where a plurality of captured images is superimposed are likely to be selected as sampling pixels for each of a plurality of captured images. That is, pixels at the same position in a plurality of captured images are likely to be selected as sampling pixels. If there is a plurality of sampling pixels at the same position in a plurality of captured images in this way, clustering is performed a plurality of times for one position. Therefore, such redundant processing is likely to increase a processing time unnecessarily.

The stitching image is generated by selecting one of captured images of an area where such a plurality of captured images is superimposed, and connecting each captured image in a state where a plurality of captured images is not superimposed. That is, in each captured image, a stitched area is set such that each captured image is not superimposed on other captured images, and a stitched area of each captured image is stitched to each other to generate a stitching image.

Furthermore, in a case where a captured image includes an outside of the area that is a clustering target (e.g., an outside of the field area), pixels in such an area are likely to be selected as sampling pixels. In such a case, pixels in an area that does not need to be clustered are likely to be clustered, and unnecessary processing is likely to increase a processing time unnecessarily.

The above-described stitched areas can be set so as not to include such unnecessary areas. Therefore, by stitching the stitched area of each captured image, it is possible to generate a stitching image that does not include an area that is not a clustering processing target.

Hence, only pixels in such stitched areas are selected as sampling pixels. That is, in the area where a plurality of captured images is superimposed, sampling pixels are selected only in one of the captured images. Furthermore, sampling pixels are selected so as not to include pixels in areas that are not clustering targets.

The stitching information is information that includes information indicating such a stitched area of each captured image. That is, the stitching information includes information regarding an area in which captured images overlap, and that is a clustering processing target. Hence, the stitched area is specified by using such stitching information, and the sampling pixels are selected only in this specified stitched area. By so doing, it is possible to suppress an increase in redundant clustering and unnecessary clustering, and suppress an increase in an unnecessary processing time.

<Image Processing Apparatus>

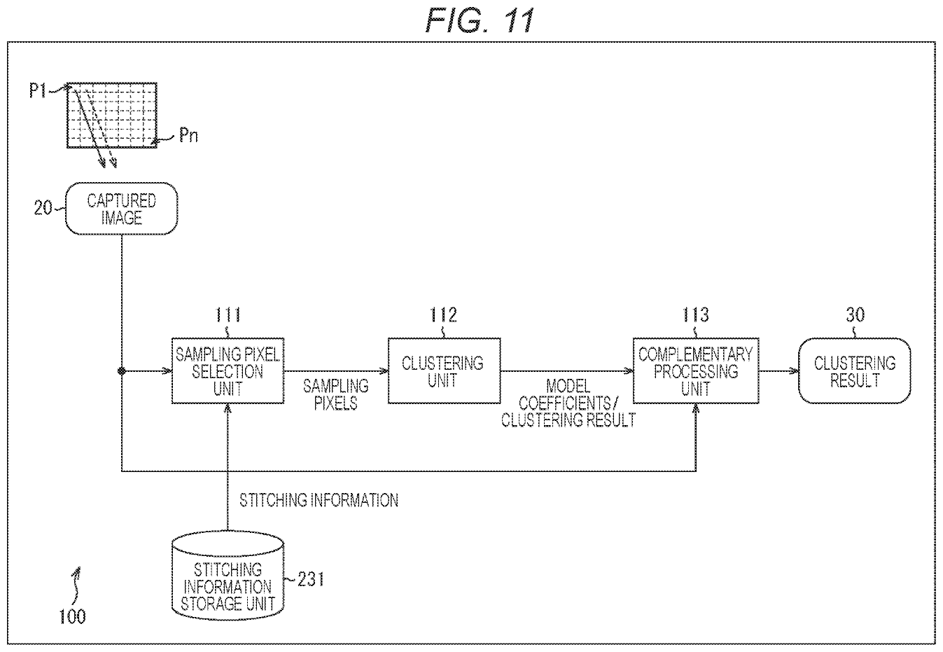

FIG. 11 is a block diagram illustrating a main configuration example of the image processing apparatus 100 in this case. The captured image 20 is a stitching image obtained by stitching a plurality of captured images obtained by imaging a clustering processing target field from the sky. As illustrated in FIG. 11, in this case, the image processing apparatus 100 includes a stitching information storage unit 231 in addition to the components illustrated in FIG. 1.

The stitching information storage unit 231 includes a storage medium, and stores stitching information that includes information indicating a stitched area of each captured image in (a storage area of) this storage medium. This information indicating the stitched area may be any information. This information may be, for example, information that indicates the stitched area by using GPS coordinate information, or may be information that indicates the stitched area by using coordinate information in the captured image.

The stitching information storage unit 231 supplies the stitching information stored in (the storage area of) the storage medium of the stitching information storage unit 231 to the sampling pixel selection unit 111 in response to, for example, a request of the sampling pixel selection unit 111.

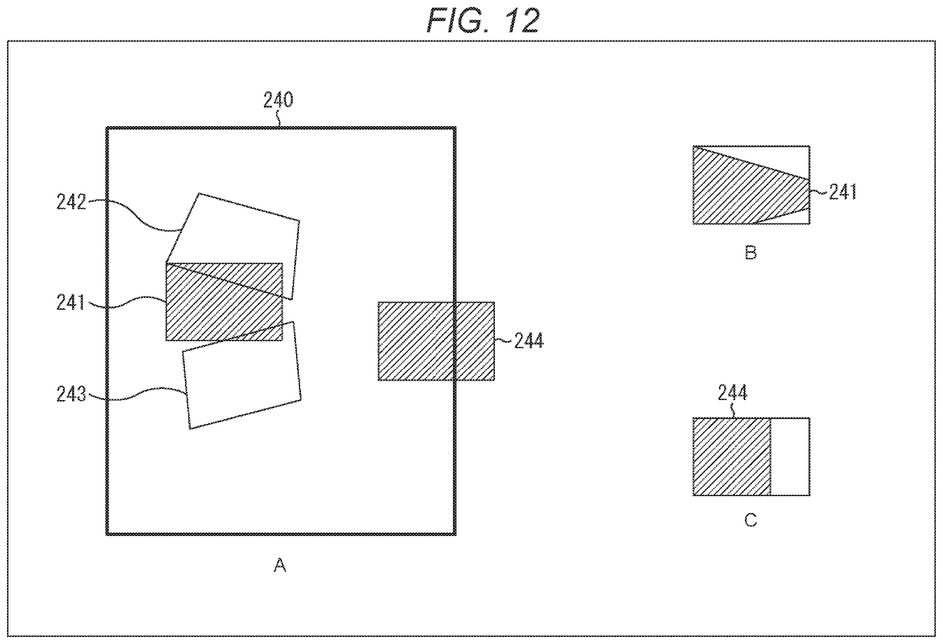

The sampling pixel selection unit 111 obtains this stitching information, and specifies the stitched area of each captured image on the basis of this stitching information. In a case where, for example, sampling pixels are selected from a captured image 241 used to generate a stitching image 240 as illustrated in A of FIG. 12, the sampling pixel selection unit 111 specifies a stitched area such as a hatched portion illustrated in B of FIG. 12 on the basis of the stitching information (by taking into account an overlap of a captured image 242 and a captured image 243 in surroundings), and selects sampling pixels in this stitched area.

In a case of the example of B of FIG. 12, the area where the captured image 241 and the captured image 242 are superimposed on each other is the stitched area of the captured image 242, and therefore the sampling pixels are selected during processing of the captured image 242. Similarly, the area where the captured image 241 and the captured image 243 are superimposed on each other is the stitched area of the captured image 243, and therefore the sampling pixels are selected during processing of the captured image 243.

Furthermore, in a case where, for example, sampling pixels are selected from a captured image 244 used to generate the stitching image 240 as illustrated in A of FIG. 12, the sampling pixel selection unit 111 specifies a stitched area such as a hatched portion illustrated in C of FIG. 12 on the basis of the stitching information (by taking a clustering target area into account), and selects sampling pixels in this stitched area.

In a case of the example in C of FIG. 12, an area of the captured image 244 outside the stitching image 240 is an extra-stitched area. That is, an area of the captured image 244 inside the stitching image 240 is a stitched area.

In this case, too, a method of selecting the sampling pixels is similar to that in the case in FIG. 1. That is, the sampling pixel selection unit 111 selects sparse sampling pixels in the stitched area indicated by the stitching information, and supplies the sparse sampling pixels to the clustering unit 112.

By so doing, the image processing apparatus 100 can prevent clustering from being performed for one position a plurality of times, and prevent clustering of unnecessary areas. That is, the image processing apparatus 100 can suppress an increase in redundant clustering and unnecessary clustering, and suppress an increase in an unnecessary processing time.

<Flow of Clustering Processing>

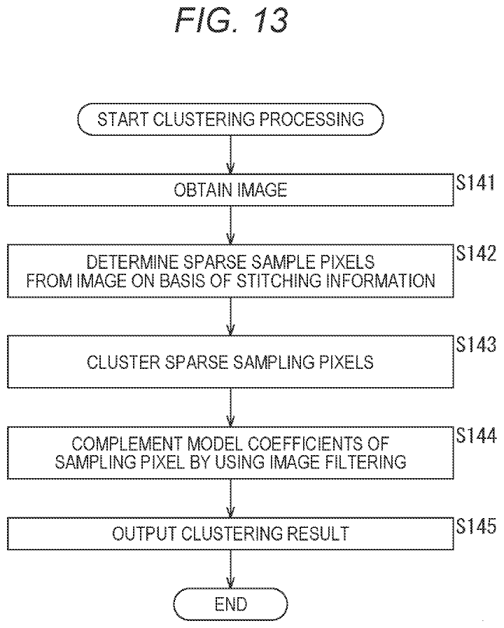

An example of a flow of the clustering processing in this case will be described with reference to a flowchart of FIG. 13. When the clustering processing is started, the sampling pixel selection unit 111 obtains the captured image 20 in step S141. Furthermore, the sampling pixel selection unit 111 obtains the stitching information from the stitching information storage unit 231.

In step S142, the sampling pixel selection unit 111 selects and determines sparse sampling pixels from the stitched area of the captured image obtained in step S141 on the basis of this stitching information.

Each processing in step S143 to step S145 is executed similar to each processing in step S103 to step S105 (FIG. 7). When the processing in step S145 ends, the clustering processing ends.

By performing each processing as described above, the image processing apparatus 100 can suppress an increase in a processing time of the image clustering.

<Use of Flat Area Information>

In general, a corner or edge portion of a captured image is a portion at which pixels having different classes from each other contact each other, and it is difficult to determine from which adjacent pixel to propagate a color. That is, clustering accuracy is higher in a flat area than in a corner or an edge.

Hence, sampling pixels are selected in the flat area, so that the pixels in the flat area can be clustered. That is, the flat area of the captured image is specified by using flat area information that is the information regarding the flat area, and the sampling pixels are selected in this flat area. By so doing, it is possible to obtain a more accurate clustering result.

<Image Processing Apparatus>

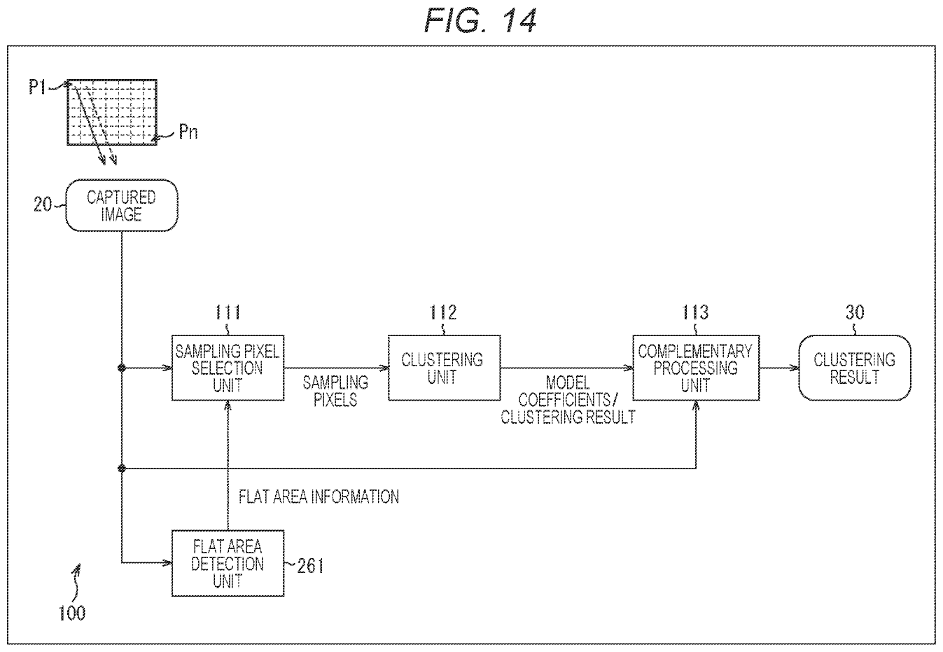

FIG. 14 is a block diagram illustrating a main configuration example of the image processing apparatus 100 in this case. As illustrated in FIG. 14, in this case, the image processing apparatus 100 includes a flat area detection unit 261 in addition to the components illustrated in FIG. 1.

The flat area detection unit 261 performs processing related to detection of a flat area. For example, the flat area detection unit 261 obtains the captured image 20.

This captured image 20 may be the same as a captured image (i.e., a captured image to be clustered) supplied to the sampling pixel selection unit 111, or a captured image (i.e., a captured image used as the guide) supplied to the interpolation processing unit 113, or may be a captured image whose time and range are substantially the same time and substantially the same range as those of the captured image to be clustered and the captured image used as the guide, and that is different from this captured image to be clustered and the captured image used as the guide. For example, the captured image 20 may be another captured image obtained by another imaging at substantially the same time and at substantially the same angle of view as imaging for obtaining the captured image to be clustered and the captured image used as the guide. For example, the captured image 20 of the wavelength range of visible light (RGB) may be supplied to the sampling pixel selection unit 111 and the interpolation processing unit 113, and the captured image 20 obtained by imaging the wavelength range of invisible light such as near-infrared ray may be supplied to the flat area detection unit 261.

Furthermore, the flat area detection unit 261 detects a flat area of this captured image. Furthermore, the flat area detection unit 261 supplies flat area information that is information indicating the detected flat area to the sampling pixel selection unit 111.

The sampling pixel selection unit 111 obtains this flat area information, and selects sampling pixels in the flat area included in captured image 20 on the basis of this flat area information. In this case, too, a method of selecting the sampling pixels is similar to that in the case in FIG. 1. That is, the sampling pixel selection unit 111 selects sparse sampling pixels in the flat area, and supplies the sparse sampling pixels to the clustering unit 112.

By so doing, the image processing apparatus 100 can obtain a more accurate clustering result.

<Flow of Clustering Processing>

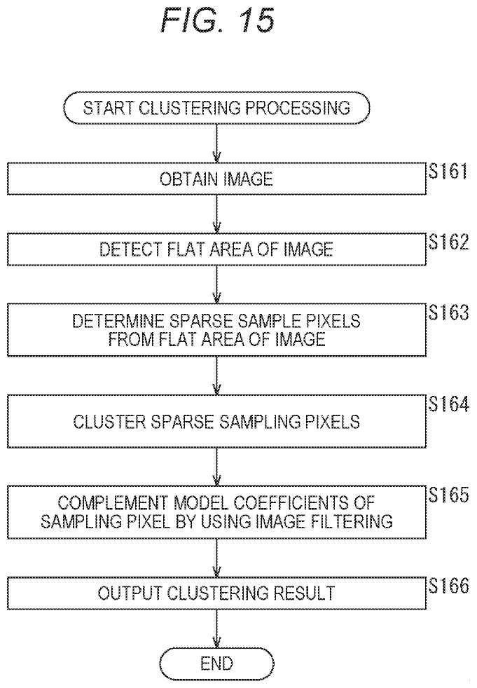

An example of a flow of the clustering processing in this case will be described with reference to a flowchart of FIG. 15. When the clustering processing is started, the sampling pixel selection unit 111 obtains the captured image 20 in step S161.

In step S162, the flat area detection unit 261 obtains the captured image 20, and detects a flat area of this captured image 20.

In step S163, the sampling pixel selection unit 111 selects and determines the sparse sampling pixels from the flat area detected in step S162 in the captured image obtained in step S161.

Each processing in step S164 to step S166 is executed similar to each processing in step 3103 to step S105 (FIG. 7). When the processing in step 3166 ends, the clustering processing ends.

By executing each processing as described above, the image processing apparatus 100 can obtain a more accurate clustering result.

<Use of a Plurality of Pieces of Information>

Although it has been described above that the image processing apparatus 100 selects sampling pixels by using one of the assist information, the stitching information, and the flat area information, the image processing apparatus 100 is not limited to this, and, for example, may select sampling pixels by using at least two or more pieces of the field information, the stitching information, and the flat area information. By so doing, it is possible to obtain an effect in a case of where each information is used. Naturally, the image processing apparatus 100 may select the sampling pixels by using one or more of these pieces of information and, in addition, information other than the above-described information.

### 2. Second Embodiment

<Wide Area Clustering and Sparse Local Clustering>

According to image clustering, by using, for example, information obtained by wide area clustering that is clustering of sparse pixels in a wide area (also referred to as a global area), local clustering that is clustering of pixels in a local area (also referred to as a local area) may be performed.

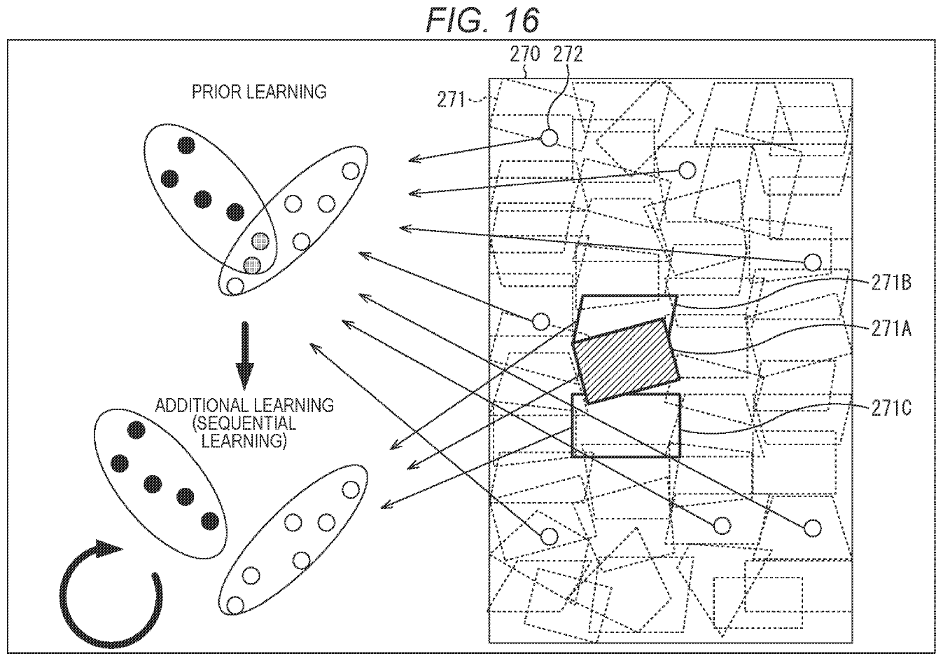

For example, as illustrated on a right side in FIG. 16, a stitching image 270 (a captured image of the entire field) obtained by stitching (stitched areas of) a plurality of captured images 271 obtained by imaging the field is clustered to analyze vegetation of this field.

According to such clustering, the entire field (the entire stitching image 270) is a wide area, and wide area clustering is performed as prior learning on this wide area (i.e., the entire stitching image 270). For example, sparse wide area sampling pixels 272 (white circles in FIG. 16) are selected from the entire stitching image 270 (the entire wide area) as wide area sampling pixels that are wide area clustering target sampling pixels. Then, the wide area sampling pixels 272 are clustered (i.e., wide area clustering).

Next, each captured image 271 (frame image) is set as a local area, and local clustering is performed as additional learning on each captured image 271 by using information (e.g., a model of learning, a clustering result, or the like) obtained by the wide area clustering. In a case where, for example, a captured image 271A is a processing target, local sampling pixels are selected as local sampling pixels that are local clustering target sampling pixels from this captured image 271A. Furthermore, the local sampling pixels are clustered (i.e., local clustering).

Note that local sampling pixels may also be selected from captured images in surroundings of the processing target captured image 271A (e.g., the one previously processed captured image 271B before the captured image 271A, one subsequently captured image 271C after the captured image 271A, and the like). Furthermore, this additional learning may be performed by using information obtained by additional learning of one previous captured image (i.e., information obtained by local clustering of the captured image 271B (e.g., a model of learning, a clustering result, or the like.)) (that is, sequential learning may be performed).

By using the information obtained by the wide area clustering in this way, it is possible to use a model estimated once, so that it is possible to obtain a model that is stable (or that is influenced little by fluctuation of an initial value) at a high speed during local clustering. Furthermore, it is possible to obtain clustering results at a high speed by targeting at sparse sampling pixels during wide area clustering, too. Consequently, it is possible to suppress an increase in a processing time while suppressing a decrease in robustness of image clustering.

The present technology described in the first embodiment is applied to such a clustering method. For example, according to the above-described local clustering, sparse local sampling pixels are clustered, sparse information (e.g., a model of learning, a clustering result, or the like.) obtained by this clustering is interpolated by image filtering that uses an image signal as a guide, and thereby a dense clustering result is derived. By so doing, it is possible to suppress for local clustering an increase in a processing time as described in the first embodiment.

<Image Processing Apparatus>

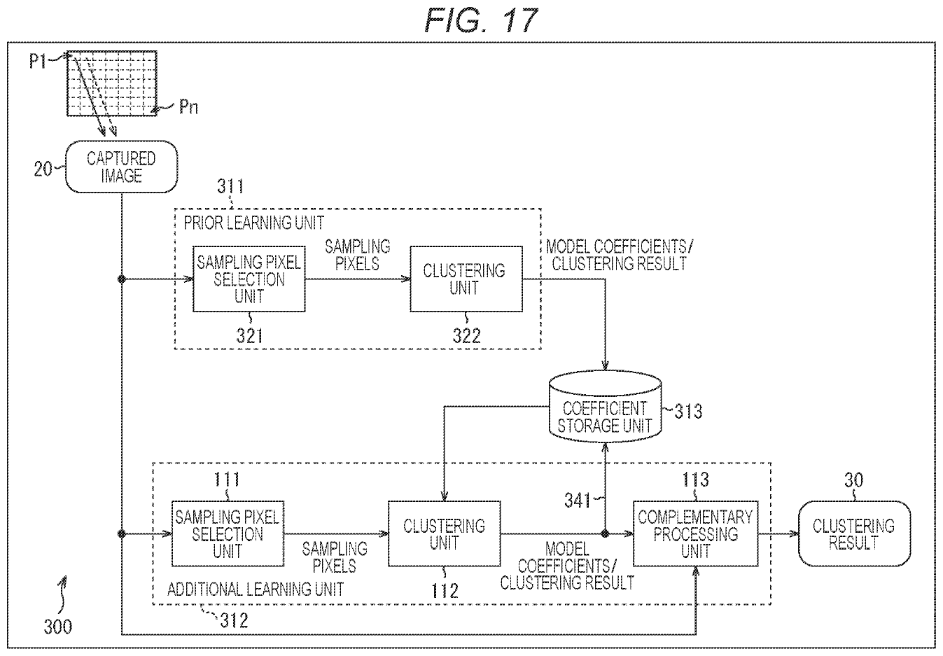

FIG. 17 is a block diagram illustrating a main configuration example of an image processing apparatus in this case.

An image processing apparatus 300 illustrated in FIG. 17 is an apparatus that performs image clustering similar to an image processing apparatus 100. That is, the image processing apparatus 300 receives a captured image 20 as input, performs the image clustering on this captured image 20, and outputs a clustering result 30 of this image clustering.

Similar to the case of the first embodiment, the captured image 20 may be, for example, a stitching image obtained by stitching a plurality of captured images (P1 to Pn). Furthermore, the captured image 20 may be a moving image including a plurality of frame images. Furthermore, the captured image 20 may be a file (captured image group) obtained by integrating a plurality of captured images into one, or may be one captured image. Naturally, the captured image 20 may be an image other than a captured image (e.g., a CG image or the like). Furthermore, this captured image 20 may be an image of a wavelength range of visible light (RGB), or may be an image obtained by imaging a wavelength range of invisible light such as near-infrared light. Furthermore, the captured image 20 may be both of these images.

In the following description, it is assumed that the captured image 20 corresponds to the stitching image 270 that is obtained by stitching the captured images 271 obtained by imaging part of the field as in the example of FIG. 16, and that corresponds to the entire field. Furthermore, the following description will describe that a wide area (global area) is this entire stitching image 270, and a local area (local area) is each captured image 271 (captured images corresponding to one frame).

Note that FIG. 17 illustrates main elements such as processing units and data flows, and the elements illustrated in FIG. 17 are not necessarily all. That is, in this image processing apparatus 300, there may be a processing unit that is not illustrated as a block in FIG. 17, or there may be processing or a data flow that is not illustrated as an arrow or the like in FIG. 17.

As illustrated in FIG. 17, the image processing apparatus 300 includes a prior learning unit 311, an additional learning unit 312, and a coefficient storage unit 313.

The prior learning unit 311 performs image clustering (wide area clustering) on a wide area (e.g., the entire captured image 20) as prior learning. In this case, the prior learning unit 311 performs wide area clustering on sparse pixels. The prior learning unit 311 includes a sampling pixel selection unit 321 and a clustering unit 322.

The sampling pixel selection unit 321 performs processing related to selection of wide area sampling pixels that are wide area clustering target pixels. For example, the sampling pixel selection unit 321 obtains the captured image 20. Furthermore, the sampling pixel selection unit 321 selects the wide area sampling pixels from this captured image 20 such that the wide area sampling pixels are in a sparse state.

The sampling pixel selection unit 321 supplies the selected sparse wide area sampling pixels to the clustering unit 322.

The clustering unit 322 performs processing related to wide area clustering. For example, the clustering unit 322 obtains the sparse wide area sampling pixels supplied from the sampling pixel selection unit 321. The clustering unit 322 performs wide area clustering (prior learning) on these obtained sparse wide area sampling pixels as processing targets. This wide area clustering method is arbitrary. For example, a Gaussian Mixture Model (GMM), a k-means method, or the like may be applied to the prior learning.

The clustering unit 322 supplies information obtained by this prior learning (wide area clustering) such as model coefficients of the prior learning, a wide area clustering result, or the like to the coefficient storage unit 313.

Furthermore, as additional learning performed by using information obtained by prior learning as an initial value, the additional learning unit 312 performs image clustering (local clustering) on a local area (e.g., each stitched captured image) by using information obtained by wide area clustering as an initial value. Similar to the image processing apparatus 100, the additional learning unit 312 clusters sparse sampling pixels, performs image filtering on sparse information obtained by this clustering by using the captured image 20 as a guide, and thereby derives a dense clustering result.

Similar to the image processing apparatus 100 (FIG. 1), the additional learning unit 312 includes a sampling pixel selection unit 111, a clustering unit 112, and an interpolation processing unit 113.

Similar to the case in FIG. 1, the sampling pixel selection unit 111 performs processing related to selection of sparse sampling pixels. For example, the sampling pixel selection unit 111 obtains the captured image 20. In this case, the entire stitching image may be supplied to the sampling pixel selection unit 111, or each captured image (frame image) that makes up the stitching image may be supplied one by one to the sampling pixel selection unit 111.

The sampling pixel selection unit 111 selects sparse sampling pixels (local sampling pixels) from each captured image (local area). In this case, the sampling pixel selection unit 111 may select captured images (local areas) in surroundings of a processing target captured image such as one previous processing target captured image (local area) and one subsequent processing target captured image (local area) as local sampling pixel selection targets. That is, the sampling pixel selection unit 111 may select sparse local sampling pixels from the processing target local area or the local areas in the surroundings of the processing target local area.

The sampling pixel selection unit 111 supplies the selected local sampling pixels to the clustering unit 112.

Similar to the case in FIG. 1, the clustering unit 112 performs local clustering on these sparse local sampling pixels, and supplies the obtained sparse information (e.g., model coefficients of additional learning, a wide area clustering result, or the like) to the interpolation processing unit 113. In this regard, the clustering unit 112 in this case obtains information obtained by prior learning (wide area clustering) stored in the coefficient storage unit 313 such as model coefficients of prior learning, a wide area clustering result, or the like, sets information (the model coefficients of the prior learning, the wide area clustering result, or the like) obtained by this prior learning as an initial value, and performs local clustering.

That is, the clustering unit 112 obtains the sparse local sampling pixels supplied from the sampling pixel selection unit 111. Furthermore, the clustering unit 112 supplies sparse information (e.g., model coefficients of the prior learning, a wide area clustering result, or the like) stored in the coefficient storage unit 313, and obtained by the prior learning (wide area clustering). The clustering unit 112 sets these obtained sparse sampling as processing targets, sets information (the model coefficients of the prior learning, the wide area clustering result, or the like) obtained by this prior learning as an initial value, and performs local clustering as additional learning. The clustering unit 112 supplies sparse information (e.g., the model coefficients of the additional learning, the local clustering result, or the like) obtained by this additional learning (local clustering) to the interpolation processing unit 113.

Note that the clustering unit 112 may further perform local clustering (current local clustering) on a current processing target local area by using information, too, obtained by performing local clustering (previous local clustering) on one previous processing target local area. That is, the clustering unit 112 may perform sequential learning by using a previous learning model, a learning result, or the like as the additional learning.

In that case, the clustering unit 112 causes the coefficient storage unit 313 to hold information (e.g., the model coefficients of the sequential learning, the local clustering result, or the like) obtained by the sequential learning. That is, the clustering unit 112 obtains, from the coefficient storage unit 313 the information obtained by the prior learning and, in addition, information obtained by previous sequential learning, too, and performs local clustering (sequential learning). Furthermore, the clustering unit 112 supplies the information (e.g., the model coefficients of the sequential learning, the local clustering result, or the like) obtained by this sequential learning to the interpolation processing unit 113, and supplies and stores the information to and in the coefficient storage unit 313. The information stored in this coefficient storage unit 313 is used for next sequential learning (local clustering for a next processing target local area).

According to such sequential learning, it is possible to derive in the local area at a high speed a clustering result that reflects a wide area clustering result and a clustering result of an adjacent local area. Consequently, it is possible to suppress an increase in a processing time while suppressing a decrease in robustness of image clustering.

In other words, in a case where the above-described sequential learning is not performed as the additional learning, it is possible to omit supply (i.e., an arrow 341 in FIG. 17) of information (the model coefficients of the additional learning, the local clustering result, or the like) obtained by the additional learning to the coefficient storage unit 313.

Similar to the case in FIG. 1, the interpolation processing unit 113 performs processing related to interpolation of the sparse information. For example, the interpolation processing unit 113 obtains the sparse information (the model coefficients of the additional learning, the clustering result, or the like) supplied from the clustering unit 112. Furthermore, the interpolation processing unit 113 performs image filtering (interpolation processing) on this sparse information by using an image signal as a guide, and derives a dense clustering result as a local clustering result. The interpolation processing unit 113 outputs the clustering result 30 (dense clustering result) obtained by this interpolation processing as an image processing result of the image processing apparatus 100 to an outside of the image processing apparatus 100.

The coefficient storage unit 313 obtains the information (the model coefficients of the prior learning and the wide area clustering result) supplied from (the clustering unit 322 of) the prior learning unit 311 and obtained by the prior learning, and stores the information in (the storage area of) the storage medium of the coefficient storage unit 313. Furthermore, in a case where the additional learning unit 312 performs sequential learning, the coefficient storage unit 313 obtains the information (the model coefficients of the sequential learning and the wide area clustering result) supplied from (the clustering unit 112 of) this additional learning unit 312 and obtained by the sequential learning, and stores the information in (the storage area of) the storage medium of the coefficient storage unit 313. Furthermore, the coefficient storage unit 313 supplies the information obtained by the prior learning and the information obtained by the sequential learning and stored in (the storage area of) the storage medium of the coefficient storage unit 313 to the clustering unit 112 on the basis of, for example, a request of the clustering unit 112.

The image processing apparatus 300 employs such a configuration, and can use a model estimated once by using information obtained by wide area clustering, so that it is possible to obtain a model that is stable (or that is influenced little by fluctuation of an initial value) at a high speed during local clustering. Furthermore, the image processing apparatus 100 can perform wide area clustering on sparse sampling pixels as targets, and obtain a clustering result at a high speed. Furthermore, the image processing apparatus 100 performs local sampling pixels on the sparse local sampling pixels, performs image filtering that uses an image as a guide on sparse information obtained by this local sampling, and thereby derives a dense clustering result at a high speed. Consequently, the image processing apparatus 300 can suppress an increase in a processing time while suppressing a decrease in robustness of image clustering.

<Flow of Clustering Processing>

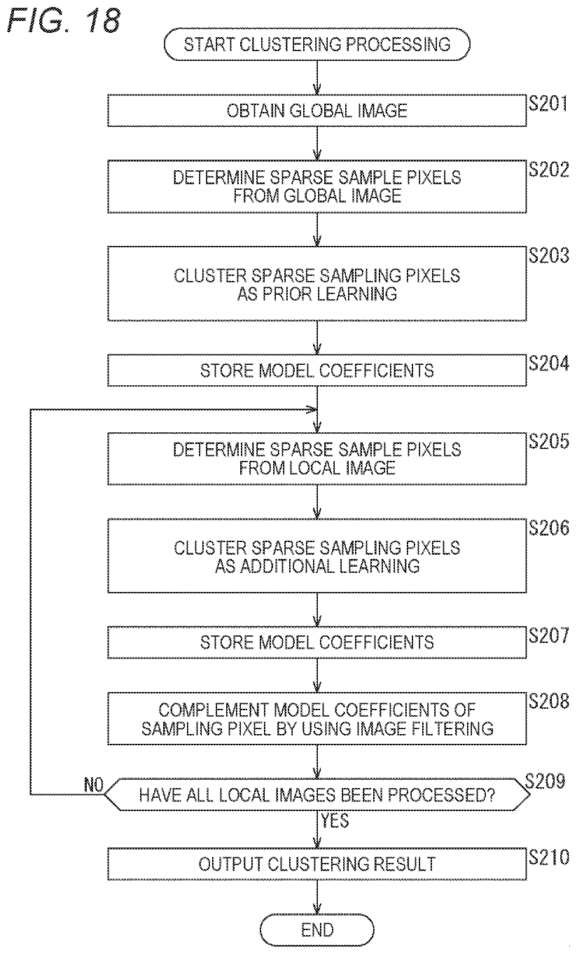

An example of a flow of the clustering processing in this case will be described with reference to a flowchart of FIG. 18. When the clustering processing is started, in step S201, the sampling pixel selection unit 321 of the prior learning unit 311 sets an image of a global area (wide area) as a global image, and obtains the captured image 20 (e.g., the stitching image 270) of a stitching image.

In step S202, the sampling pixel selection unit 321 selects and determines sparse wide area sampling pixels from the global image obtained in step S201.

In step S203, the clustering unit 322 performs wide area clustering as prior learning on the sparse wide area sampling pixels determined in step S202.

In step S204, the coefficient storage unit 313 stores the information (e.g., the model coefficients of the prior learning or the wide area clustering result) obtained by the prior learning performed in step S203.

In step S205, the sampling pixel selection unit 111 of the additional learning unit 312 obtains a processing target local image from a plurality of local images (images of local areas (local areas)) included in the global image obtained in step S201. Furthermore, the sampling pixel selection unit 111 selects and determines sparse local sampling pixels from this processing target local image.

In step S206, the clustering unit 112 performs local clustering as additional learning on the sparse local sampling pixels determined in step S205. In this case, the clustering unit 112 performs sequential learning by using the information stored in the coefficient storage unit 313 and obtained by the prior learning, and the information obtained by previous additional learning (sequential learning).

In step S207, the coefficient storage unit 313 stores the information (e.g., the model coefficients of the prior learning or the local clustering result) obtained by the additional learning (sequential learning) performed in step S206.

In step S208, the interpolation processing unit 113 obtains the captured image 20, performs image filtering on sparse information (the model coefficients of the additional learning and the clustering result) obtained by the processing in step S206 by using this captured image 20 as a guide, interpolates this sparse information, and derives a dense clustering result.

In step S209, the additional learning unit 312 determines whether or not the additional learning has been performed on all local images. In a case where it is determined that there is an unprocessed local image, the processing returns to step S205 to execute subsequent processing with respect to a next local image as a processing target. That is, each processing in step S205 to step S209 is executed for each local image. In a case where it is determined in step S209 that all the local images have been processed, the processing proceeds to step S210.

In step S210, the interpolation processing unit 113 outputs the clustering result 30 optimized as described above. When the processing in step S210 ends, the clustering processing ends.

By executing each processing as described above, the image processing apparatus 300 can suppress an increase in a processing time while suppressing a decrease in robustness of image clustering.

In other words, note that, in a case where sequential learning is not performed as additional learning, it is possible to omit the processing in step S207. Furthermore, in step S206, the clustering unit 112 performs the additional learning by using the information stored in the coefficient storage unit 313 and obtained by the prior learning.

<Reference of Wide Area Sampling Pixels>

Note that local sampling pixels may be selected by taking a selection result of wide area sampling pixels into account. For example, the local sampling pixels may be selected from pixels other than the wide area sampling pixels. That is, the wide area sampling pixels may be excluded from local sampling pixel candidates.

Furthermore, in a case where the additional learning unit 312 (clustering unit 112) performs sequential learning as the additional learning for performing current local clustering by using information obtained by previous local clustering, the sampling pixel selection unit 111 may further select current local sampling pixels by taking a selection result of previous local sampling pixels into account. For example, the current local sampling pixels may be selected from pixels other than the previous local sampling pixels. That is, the previous local sampling pixels may be excluded from the current local sampling pixel candidates.

As described above, by excluding the wide area sampling pixels and performing local clustering during additional learning, it is possible to suppress an increase in redundancy of clustering, and further suppress a decrease in robustness of image clustering. Furthermore, by excluding previous local sampling pixels and performing current local clustering during sequential learning, it is possible to suppress an increase in redundancy of clustering, and further suppress a decrease in robustness of image clustering. Consequently, it is possible to suppress an increase in a processing time while suppressing a decrease in robustness of image clustering.

<Image Processing Apparatus>

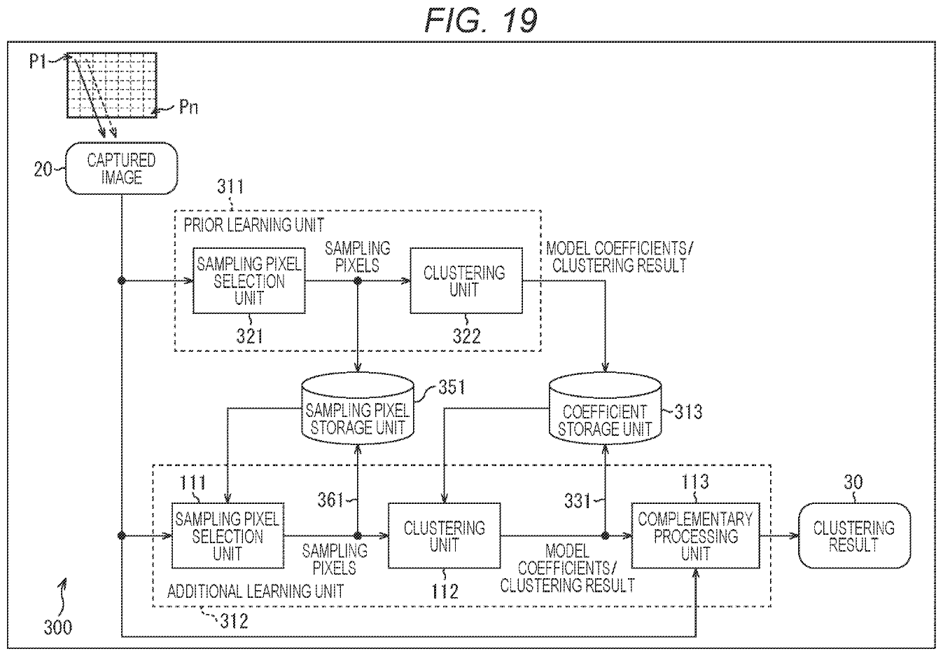

FIG. 19 is a block diagram illustrating a main configuration example of the image processing apparatus 300 in this case. As illustrated in FIG. 19, the image processing apparatus 300 in this case includes a sampling pixel storage unit 351 in addition to the components in the example in FIG. 17.

In this case, the sampling pixel selection unit 321 of the prior learning unit 311 supplies the selected wide area sampling pixels to the clustering unit 322, and supplies the selected wide area sampling pixels to the sampling pixel storage unit 351, too.

The sampling pixel storage unit 351 includes a storage medium, and performs processing related to storage of sampling pixels. For example, the sampling pixel storage unit 351 obtains the wide area sampling pixels supplied from (the sampling pixel selection unit 321 of) the prior learning unit 311, and stores the wide area sampling pixels in (the storage area of) the storage medium of the sampling pixel storage unit 351.

Furthermore, the sampling pixel storage unit 351 supplies the wide area sampling pixels stored in (the storage area of) the storage medium of the sampling pixel storage unit 351 to the sampling pixel selection unit 111 on the basis of, for example, a request of the sampling pixel selection unit 111.

In this case, the sampling pixel selection unit 111 obtains the wide area sampling pixels stored in the sampling pixel storage unit 351. The sampling pixel selection unit 111 selects sparse local sampling pixels from pixels other than these wide area sampling pixels in a processing target local area (frame image), and supplies the sparse local sampling pixels to the clustering unit 112. By so doing, the clustering unit 112 can suppress an increase in redundancy of clustering, and further suppress a decrease in robustness of image clustering.

Note that, in a case where the additional learning unit 312 performs sequential learning, the sampling pixel selection unit 111 of the additional learning unit 312 supplies the selected local sampling pixels to the clustering unit 112, and supplies the selected local sampling pixels to the sampling pixel storage unit 351, too.

In this case, the sampling pixel storage unit 351 obtains the local sampling pixels supplied from (the sampling pixel selection unit 111 of) this additional learning unit 312, and stores the information in (the storage area of) the storage medium of the sampling pixel storage unit 351. Furthermore, the sampling pixel storage unit 351 supplies the wide area sampling pixels and the previous local sampling pixels stored in (the storage area of) the storage medium of the sampling pixel storage unit 351 to the sampling pixel selection unit 111 on the basis of, for example, a request of the sampling pixel selection unit 111.

Then, the sampling pixel selection unit 111 obtains these wide area sampling pixels and previous local sampling pixels from the sampling pixel storage unit 351. The sampling pixel selection unit 111 selects sparse local sampling pixels from pixels other than these wide area sampling pixels and previous local sampling pixels in a processing target local area (frame image), and supplies the sparse local sampling pixels to the clustering unit 112. By so doing, the clustering unit 112 can suppress an increase in redundancy of clustering, and further suppress a decrease in robustness of image clustering.

In other words, in a case where the above-described sequential learning is not performed as the additional learning, it is possible to omit supply (i.e., an arrow 361 in FIG. 19) of the local sampling pixels to the sampling pixel storage unit 351.

<Flow of Clustering Processing>

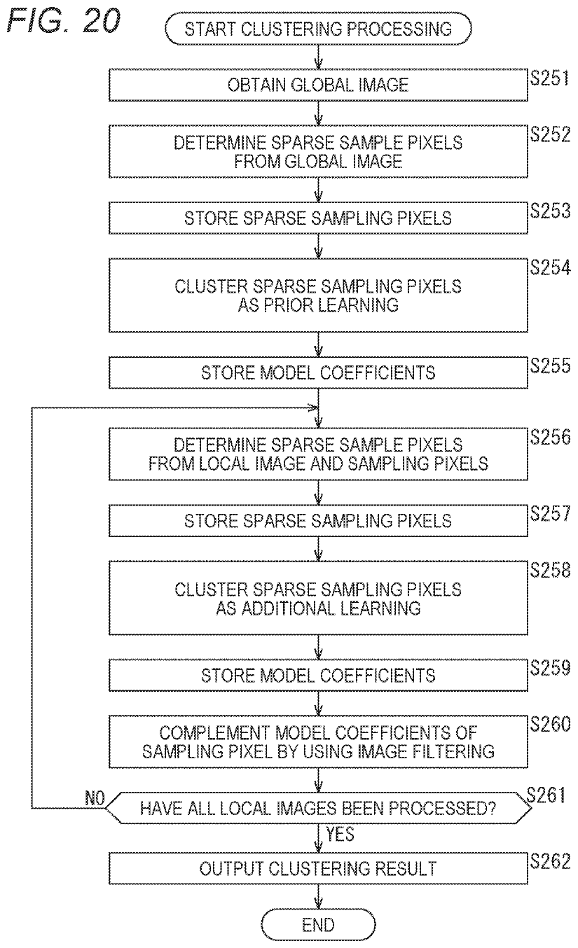

An example of a flow of the clustering processing executed by the image processing apparatus 300 in this case will be described with reference to a flowchart of FIG. 20. When the clustering processing is started, each processing in step S251 and step S252 is executed similar to each processing in step S201 and step S202 (FIG. 18).

In step S253, the sampling pixel storage unit 351 stores the sparse wide area sampling pixels determined in step S252.

When the processing in step S253 ends, each processing in step S254 and step S255 is executed similar to each processing in step S203 and step S204 (FIG. 18).

In step S256, the sampling pixel selection unit 111 of the additional learning unit 312 obtains a processing target local image from a local image group included in the global image obtained in step S251. Furthermore, the sampling pixel selection unit 111 selects sparse local sampling pixels from pixels other than the wide area sampling pixels and the previous local sampling pixels in this processing target local image.

In step S257, the sampling pixel storage unit 351 stores the sparse local sampling pixels (current local sampling pixels) determined in step S256.

When step S257 ends, each processing in step S258 to step S260 is executed similar to each processing in step S206 to step S208 (FIG. 18).

In step S261, the additional learning unit 312 determines whether or not the additional learning has been performed on all local images. In a case where it is determined that there is an unprocessed local image, the processing returns to step S256 to execute subsequent processing with respect to a next local image as a processing target. That is, each processing in step S256 to step S261 is executed for each local image. In a case where it is determined in step S261 that all the local images have been processed, the processing proceeds to step S262.

In step S262, the interpolation processing unit 113 outputs the clustering result 30 optimized as described above. When the processing in step S262 ends, the clustering processing ends.

By executing each processing as described above, the image processing apparatus 300 can suppress an increase in a processing time while suppressing a decrease in robustness of image clustering.

In other words, note that, in a case where sequential learning is not performed as additional learning, it is possible to omit the processing in step S255 and step S259. Furthermore, in step S256, the sampling pixel selection unit 111 selects sampling pixels by using the wide area sampling pixels stored in the sampling pixel storage unit 351. Furthermore, in step S258, the clustering unit 112 performs the additional learning by using the information stored in the coefficient storage unit 313 and obtained by the prior learning.

<Other Components>

Note that the prior learning unit 311 may be a component of another apparatus in the image processing apparatus 300 in FIG. 17. That is, the image processing apparatus 300 may include the additional learning unit 312 and the coefficient storage unit 313. In this case, the coefficient storage unit 313 obtains and stores sparse information (model coefficients of prior learning, a clustering result, or the like) obtained by the prior learning unit 311 of) the another apparatus. Furthermore, the additional learning unit 312 performs local clustering on sparse local sampling pixels by using the sparse information stored in the coefficient storage unit 313 and obtained by (the prior learning unit 311 of) the another apparatus.

Furthermore, the prior learning unit 311 and the coefficient storage unit 313 may be components of another apparatus in the image processing apparatus 300 in FIG. 17. That is, the image processing apparatus 300 may include the additional learning unit 312. In this case, the additional learning unit 312 performs local clustering on sparse local sampling pixels by using the sparse information stored in (the coefficient storage unit 313) of the another apparatus and obtained by (the prior learning unit 311 of) the another apparatus.

In both of the cases, similar to the case in FIG. 17, the image processing apparatus 300 can suppress an increase in a processing time while suppressing a decrease in robustness of image clustering.

Furthermore, the prior learning unit 311 may be a component of another apparatus in the image processing apparatus 300 in FIG. 19. That is, the image processing apparatus 300 may include the additional learning unit 312, the coefficient storage unit 313, and the sampling pixel storage unit 351. In this case, the coefficient storage unit 313 obtains and stores sparse information (model coefficients of prior learning, a clustering result, or the like) obtained by the prior learning unit 311 of) the another apparatus. Furthermore, the sampling pixel storage unit 351 obtains and stores sparse wide area sampling pixels selected by (the prior learning unit 311 of) the another apparatus. Furthermore, the additional learning unit 312 selects sparse local sampling pixels on the basis of the sparse wide area sampling pixels stored in the sampling pixel storage unit 351 and selected by (the prior learning unit 311 of) the another apparatus, and performs local clustering on these selected sparse local sampling pixels by using the sparse information stored in the coefficient storage unit 313 and obtained by (the prior learning unit 311 of) the another apparatus.

Furthermore, the prior learning unit 311 and the coefficient storage unit 313 may be components of another apparatus in the image processing apparatus 300 in FIG. 19. That is, the image processing apparatus 300 may include the additional learning unit 312 and the sampling pixel storage unit 351. In this case, the sampling pixel storage unit 351 obtains and stores wide area sampling pixels selected by (the prior learning unit 311 of) the another apparatus. Furthermore, the additional learning unit 312 selects sparse local sampling pixels on the basis of the sparse wide area sampling pixels stored in the sampling pixel storage unit 351 and selected by (the prior learning unit 311 of) the another apparatus, and performs local clustering on these selected sparse local sampling pixels by using the sparse information stored in (the coefficient storage unit 313 of) of the another apparatus and obtained by (the prior learning unit 311 of) the another apparatus.

Furthermore, the prior learning unit 311 and the sampling pixel storage unit 351 may be components of another apparatus in the image processing apparatus 300 in FIG. 19. That is, the image processing apparatus 300 may include the additional learning unit 312 and the coefficient storage unit 313. In this case, the coefficient storage unit 313 obtains and stores information (model coefficients of prior learning, a clustering result, or the like) obtained by (the prior learning unit 311 of) the another apparatus. Furthermore, the additional learning unit 312 selects sparse local sampling pixels on the basis of the sparse wide area sampling pixels stored in (the sampling pixel storage unit 351) of the another apparatus and selected by (the prior learning unit 311 of) the another apparatus, and performs local clustering on these selected sparse local sampling pixels by using the sparse information stored in the coefficient storage unit 313 and obtained by (the prior learning unit 311 of) the another apparatus.

Furthermore, the prior learning unit 311, the coefficient storage unit 313, and the sampling pixel storage unit 351 may be components of another apparatus in the image processing apparatus 300 in FIG. 19. That is, the image processing apparatus 300 may include the additional learning unit 312. In this case, the additional learning unit 312 selects sparse local sampling pixels on the basis of the sparse wide area sampling pixels stored in (the sampling pixel storage unit 351 of) the another apparatus and selected by (the prior learning unit 311 of) the another apparatus, and performs local clustering on these selected sparse local sampling pixels by using the sparse information stored in (the coefficient storage unit 313 of) of the another apparatus and obtained by (the prior learning unit 311 of) the another apparatus.

In both of the cases, similar to the case in FIG. 19, the image processing apparatus 300 can suppress an increase in a processing time while suppressing a decrease in robustness of image clustering.

Naturally, in each of these cases, the additional learning unit 312 can perform the above-described sequential learning as the additional learning similar to the cases in FIGS. 17 and 19.

Furthermore, the image processing apparatus 300 may select the local sampling pixels by using at least one or more of field information, stitching information, and flat area information described in the first embodiment. By doing so, it is possible to obtain an effect in a case where each information is used for the additional learning. Naturally, the image processing apparatus 300 may select the sampling pixels by using one or more of these pieces of information and, in addition, information other than the above-described information.

Note that, although the present embodiment has described the case where the captured image 20 is a stitching image, the present embodiment is not limited to this, and the captured image 20 may be a moving image including a plurality of frame images, may be a file (captured image group) obtained by integrating a plurality of captured images into one, or may be one captured image. Naturally, the captured image 20 may be an image other than a captured image (e.g., a CG image or the like). Furthermore, this captured image 20 may be an image of a wavelength range of visible light (RGB), or may be an image obtained by imaging a wavelength range of invisible light such as near-infrared light. Furthermore, the captured image 20 may be both of these images.

Furthermore, a wide area (global area) may not be the entire captured image 20, or a local area (local area) may not be captured images corresponding to one frame. The local area may be an area of the wide area that is narrower than the wide area. As long as this applies, each of the wide area and the local area may be any area in the captured image 20.

### 3. Third Embodiment

<Wide Area Clustering and Dense Local Clustering>

As described above in the second embodiment, according to image clustering, local clustering may be performed by using, for example, sparse information obtained by wide area clustering of sparse wide area sampling pixels. Then, this local clustering may be performed on local sampling pixels in a dense state. That is, instead of performing local clustering on sparse local sampling pixels, performing image filtering that uses an image signal as a guide on the obtained sparse information, and thereby deriving a dense clustering result as in the second embodiment, local clustering may be performed on local sampling pixels in a dense state.

In this case, too, similar to the case of the second embodiment, a model estimated once by wide area clustering can be used, so that it is possible to obtain a model that is stable (or that is influenced little by fluctuation of an initial value) at a high speed during local clustering. Furthermore, it is possible to obtain clustering results at a high speed by targeting at sparse sampling pixels during wide area clustering, too. Consequently, it is possible to suppress an increase in a processing time while suppressing a decrease in robustness of image clustering.

<Image Processing Apparatus>

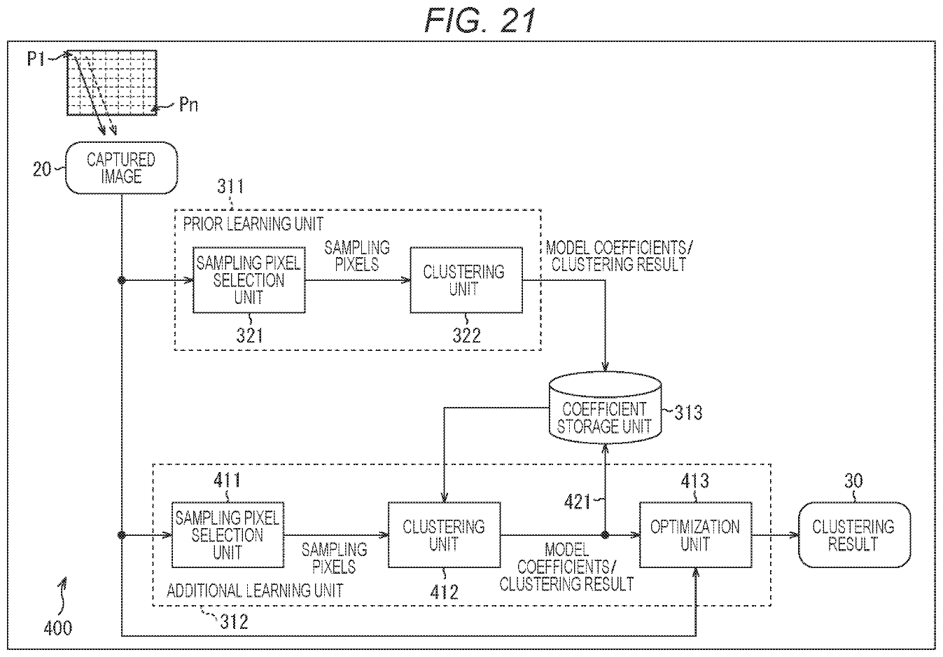

FIG. 21 is a block diagram illustrating a main configuration example of an image processing apparatus in this case. An image processing apparatus 400 illustrated in FIG. 21 is an apparatus that performs image clustering similar to an image processing apparatus 300. That is, the image processing apparatus 400 receives a captured image 20 as input, performs the image clustering on this captured image 20, and outputs a clustering result 30 of this image clustering.

Similar to the case of the second embodiment, the captured image 20 may be, for example, a stitching image obtained by stitching a plurality of captured images (P1 to Pn). Furthermore, the captured image 20 may be a moving image including a plurality of frame images. Furthermore, the captured image 20 may be a file (captured image group) obtained by integrating a plurality of captured images into one, or may be one captured image. Naturally, the captured image 20 may be an image other than a captured image (e.g., a CG image or the like). Furthermore, this captured image 20 may be an image of a wavelength range of visible light (RGB), or may be an image obtained by imaging a wavelength range of invisible light such as near-infrared light. Furthermore, the captured image 20 may be both of these images.

In the following description, it is assumed that the captured image 20 corresponds to a stitching image 270 that is obtained by stitching captured images 271 obtained by imaging part of a field as in the example of FIG. 16, and that corresponds to the entire field. Furthermore, the following description will describe that a wide area (global area) is this entire stitching image 270, and a local area (local area) is each captured image 271 (captured images corresponding to one frame).

Note that FIG. 21 illustrates main elements such as processing units and data flows, and the elements illustrated in FIG. 21 are not necessarily all. That is, in this image processing apparatus 400, there may be a processing unit that is not illustrated as a block in FIG. 21, or there may be processing or a data flow that is not illustrated as an arrow or the like in FIG. 21.

As illustrated in FIG. 21, the image processing apparatus 400 includes a prior learning unit 311, an additional learning unit 312, and a coefficient storage unit 313 similar to the image processing apparatus 300 (FIG. 17).

Similar to the case of the image processing apparatus 300 (FIG. 17), the prior learning unit 311 includes a sampling pixel selection unit 321 and a clustering unit 322, and performs wide area clustering on sparse wide area sampling pixels as prior learning, and supplies information obtained by this prior learning to the coefficient storage unit 313. The information obtained by this prior learning is information that is obtained by wide area clustering, and corresponds to each sampling pixel (i.e., a sparse state). For example, the information may be model coefficients of prior learning, may be a clustering result, or may be both of the model coefficients of learning and the clustering result.

The coefficient storage unit 313 employs a configuration similar to that of the image processing apparatus 300 (FIG. 17), and stores sparse information (e.g., the model coefficients of prior learning, a wide area clustering result, or the like) supplied from the prior learning unit 311. Furthermore, the coefficient storage unit 313 supplies the stored sparse information to (a clustering unit 412 of) the additional learning unit 312 in response to, for example, a request of (the clustering unit 412 of) the additional learning unit 312.

Similar to the case of the image processing apparatus 300 (FIG. 17), the additional learning unit 312 performs additional learning by using as an initial value the sparse information (e.g., the model coefficients of prior learning, the wide area clustering result, or the like) obtained by the prior learning. In this regard, the additional learning unit 312 in this case performs local clustering as additional learning on dense local sampling pixels, and derives a dense clustering result.

This local clustering method is arbitrary. For example, a Structure-constrained Gaussian Mixture Model (SC-GMM) may be applied to this additional learning. According to the SC-GAMM, optimization that takes image structure information into account for clustering in a color space is derived. For example, a structure of a texture or an edge is used to obtain an adjacent relationship between pixels, and classification is performed on the basis of this adjacent relationship. By so doing, it is possible to perform more accurate clustering.

As illustrated in FIG. 21, the additional learning unit 312 in this case includes a sampling pixel selection unit 411, the clustering unit 412, and an optimization unit 413.

The sampling pixel selection unit 411 performs processing related to selection of local sampling pixels. For example, the sampling pixel selection unit 411 obtains the captured image 20. In this case, an entire stitching image may be supplied to the sampling pixel selection unit 411, or each captured image (frame image) that makes up a stitching image may be supplied one by one to the sampling pixel selection unit 411.

Furthermore, the sampling pixel selection unit 411 selects part or all of pixels of each captured image (local area) as local sampling pixels. In this case, the sampling pixel selection unit 411 selects the local sampling pixels such that the local sampling pixels are in a dense state. Note that the sampling pixel selection unit 411 selects captured images (local areas) in surroundings of a processing target captured image such as one previous processing target captured image (local area) and one subsequent processing target captured image (local area) as local sampling pixel selection targets. That is, the sampling pixel selection unit 411 may select dense local sampling pixels from a processing target local area or local areas in the surroundings of the processing target local area.

The sampling pixel selection unit 411 supplies the selected dense local sampling pixels to the clustering unit 412.

The clustering unit 412 performs processing related to local clustering. For example, the clustering unit 412 obtains dense local sampling pixels supplied from the sampling pixel selection unit 411. Furthermore, the clustering unit 412 supplies sparse information (e.g., model coefficients of the prior learning, a wide area clustering result, or the like) stored in the coefficient storage unit 313, and obtained by prior learning (wide area clustering).

The clustering unit 412 sets the sparse information obtained by this prior learning as an initial value, and performs local clustering that is dense local sampling. The clustering unit 412 supplies information obtained by this additional learning (local clustering of the dense local sampling pixels) to the optimization unit 413. The information obtained by this additional learning is information that is obtained by local clustering, and corresponds to each sampling pixel (that is, that is in a dense state). For example, the information may be model coefficients of the additional learning, may be a clustering result, or may be both of the model coefficients of learning and the clustering result.

Note that the clustering unit 412 may further perform local clustering (current local clustering) on a current processing target local area by using information, too, obtained by performing local clustering (previous local clustering) on one previous processing target local area. That is, the clustering unit 412 may perform sequential learning that uses a previous learning model, a clustering result, or the like as the additional learning.

In that case, the clustering unit 412 causes the coefficient storage unit 313 to hold dense information (e.g., model coefficients of the sequential learning, a local clustering result, or the like) obtained by the sequential learning. Furthermore, the clustering unit 412 obtains, from the coefficient storage unit 313, the sparse information obtained by the prior learning and, in addition, dense information obtained by previous sequential learning, too, and performs local clustering (sequential learning). Furthermore, the clustering unit 412 supplies the information (e.g., the model coefficients of the sequential learning, the local clustering result, or the like) obtained by this sequential learning to the optimization unit 413, and supplies and stores the information to and in the coefficient storage unit 313. The information stored in this coefficient storage unit 313 is used for next sequential learning (local clustering for a next processing target local area).

According to such sequential learning, it is possible to derive in the local area at a high speed a clustering result that reflects a wide area clustering result and a clustering result of an adjacent local area. Consequently, it is possible to suppress an increase in a processing time while suppressing a decrease in robustness of image clustering.

In other words, in a case where the above-described sequential learning is not performed as the additional learning, it is possible to omit supply (i.e., an arrow 421 in FIG. 21) of information (the model coefficients of the additional learning, the local clustering result, or the like) obtained by the additional learning to the coefficient storage unit 313.

The optimization unit 413 performs processing related to optimization of a clustering result. For example, the optimization unit 413 obtains the information (e.g., the model coefficients of the additional learning, the local clustering result, or the like) supplied from the clustering unit 412 and obtained by the additional learning. Furthermore, the optimization unit 413 obtains the captured image 20.

This captured image 20 may be the same as the captured image 20 (i.e., the captured image to be clustered) supplied to the sampling pixel selection unit 321 and the sampling pixel selection unit 411, or may be a captured image whose time and range are substantially the same time and substantially the same range as those of the captured image to be clustered, and that is different from this captured image to be clustered. For example, the captured image 20 may be another captured image obtained by another imaging at substantially the same time and at substantially the same angle of view as imaging for obtaining the captured image to be clustered. For example, the captured image 20 of the wavelength range of visible light (RGB) may be supplied to the sampling pixel selection unit 321 and the sampling pixel selection unit 411, and the captured image 20 obtained by imaging the wavelength range of invisible light such as near-infrared ray may be supplied to the optimization unit 413.

The optimization unit 413 optimizes the dense information obtained by the additional learning by using this captured image 20, and derives an optimized dense clustering result. For example, the optimization unit 413 obtains an adjacent relationship between pixels by taking image structure information (a structure of a texture or an edge) of this captured image 20 into account, and optimizes model coefficients and a clustering result on the basis of this adjacent relationship.

The optimization unit 413 outputs the clustering result 30 (i.e., the clustering result on which the optimization processing has been performed) obtained by this processing as an image processing result of the image processing apparatus 400 to an outside of the image processing apparatus 400.

The image processing apparatus 400 employs such a configuration, so that it is possible to perform local clustering by using a model estimated once by wide area clustering. Consequently, the image processing apparatus 400 can obtain a model that is stable (or that is influenced little by fluctuation of an initial value) at a high speed during local clustering. Furthermore, the image processing apparatus 400 employs such a configuration, so that it is possible to obtain a clustering result at a high speed by targeting at sparse sampling pixels during wide area clustering, too. Consequently, the image processing apparatus 400 can suppress an increase in a processing time while suppressing a decrease in robustness of image clustering.

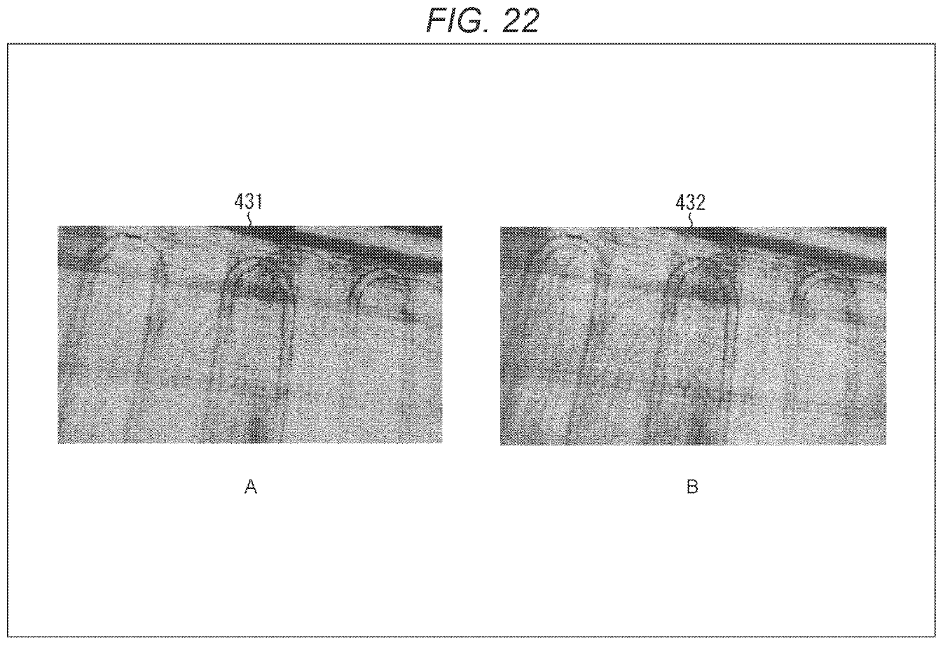

A clustering result 431 illustrated in A of FIG. 22 illustrates an example of a clustering result derived by the image processing apparatus 400. Furthermore, a clustering result 432 illustrated in B of FIG. 22 illustrates an example of a clustering result derived by the image processing apparatus 300. That is, each image processing apparatus can obtain a substantially similar clustering result. That is, similar to the case of the image processing apparatus 300, the image processing apparatus 400 can suppress an increase in a processing time while suppressing a decrease in robustness of image clustering.

<Flow of Clustering Processing>

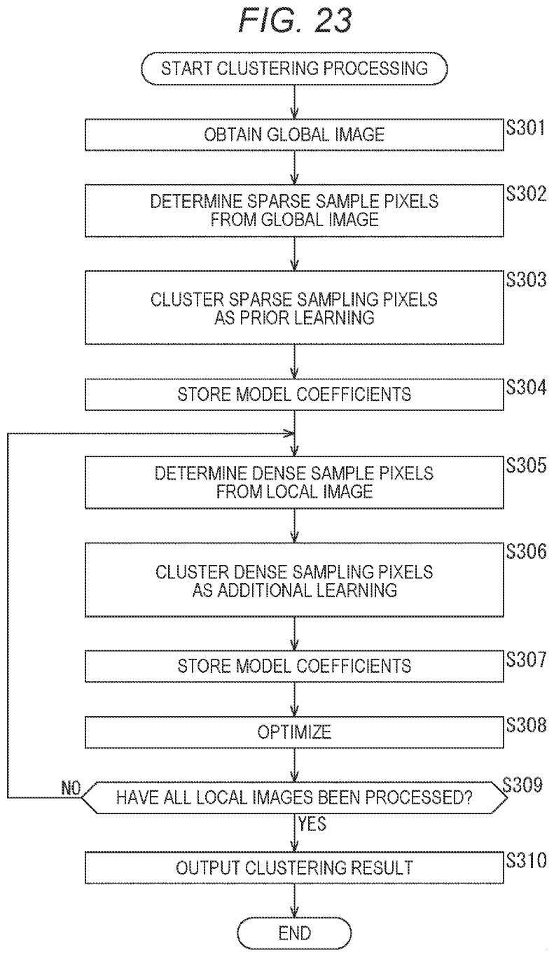

An example of a flow of the clustering processing executed by this image processing apparatus 400 will be described with reference to a flowchart of FIG. 23. When the clustering processing is started, each processing in step S301 to step S304 is executed similar to each processing in step S201 to step S204 (FIG. 18).

In step S305, the sampling pixel selection unit 411 of the additional learning unit 312 obtains a processing target local image from a local image group included in the global image obtained in step S301. Furthermore, the sampling pixel selection unit 411 selects and determines dense local sampling pixels from this processing target local image.

In step S306, the clustering unit 412 performs local clustering as additional learning on the dense local sampling pixels determined in step S305. In this case, the clustering unit 412 performs sequential learning by using the information stored in the coefficient storage unit 313 and obtained by the prior learning, and the information obtained by previous additional learning (sequential learning).

In step S307, the coefficient storage unit 313 stores the information (e.g., the model coefficients of the prior learning or the local clustering result) obtained by the additional learning (sequential learning) performed in step S306.

In step S308, the optimization unit 413 stores the information (e.g., the model coefficients and the local clustering result of the additional learning) obtained by the additional learning (sequential learning) performed in step S306, and derives an optimized clustering result.

In step S309, the additional learning unit 312 determines whether or not the additional learning has been performed on all local images. In a case where it is determined that there is an unprocessed local image, the processing returns to step S305 to execute subsequent processing with respect to a next local image as a processing target. That is, each processing in step S305 to step S309 is executed for each local image. In a case where it is determined in step S309 that all the local images have been processed, the processing proceeds to step S310.

In step S310, the optimization unit 413 outputs the clustering result 30 optimized as described above. When the processing in step S310 ends, the clustering processing ends.

By executing each processing as described above, the image processing apparatus 400 can suppress an increase in a processing time while suppressing a decrease in robustness of image clustering.

In other words, note that, in a case where sequential learning is not performed as additional learning, it is possible to omit the processing in step S307. Furthermore, in step S306, the clustering unit 412 performs the additional learning by using the information stored in the coefficient storage unit 313 and obtained by the prior learning.

<Reference of Wide Area Sampling Pixels>

Note that, similar to the case of the image processing apparatus 300 described in the second embodiment, local sampling pixels may be selected by taking a selection result of wide area sampling pixels into account. For example, the local sampling pixels may be selected from pixels other than the wide area sampling pixels. That is, the wide area sampling pixels may be excluded from local sampling pixel candidates.

Furthermore, in a case where the additional learning unit 312 (clustering unit 412) performs sequential learning as the additional learning for performing current local clustering by using information obtained by previous local clustering, the sampling pixel selection unit 411 may further select current local sampling pixels by taking a selection result of previous local sampling pixels into account. For example, the current local sampling pixels may be selected from pixels other than the previous local sampling pixels. That is, the previous local sampling pixels may be excluded from the current local sampling pixel candidates.

As described above, by excluding the wide area sampling pixels and performing local clustering during additional learning, it is possible to suppress an increase in redundancy of clustering, and further suppress a decrease in robustness of image clustering. Furthermore, by excluding previous local sampling pixels and performing current local clustering during sequential learning, it is possible to suppress an increase in redundancy of clustering, and further suppress a decrease in robustness of image clustering. Consequently, it is possible to suppress an increase in a processing time while suppressing a decrease in robustness of image clustering.

<Image Processing Apparatus>

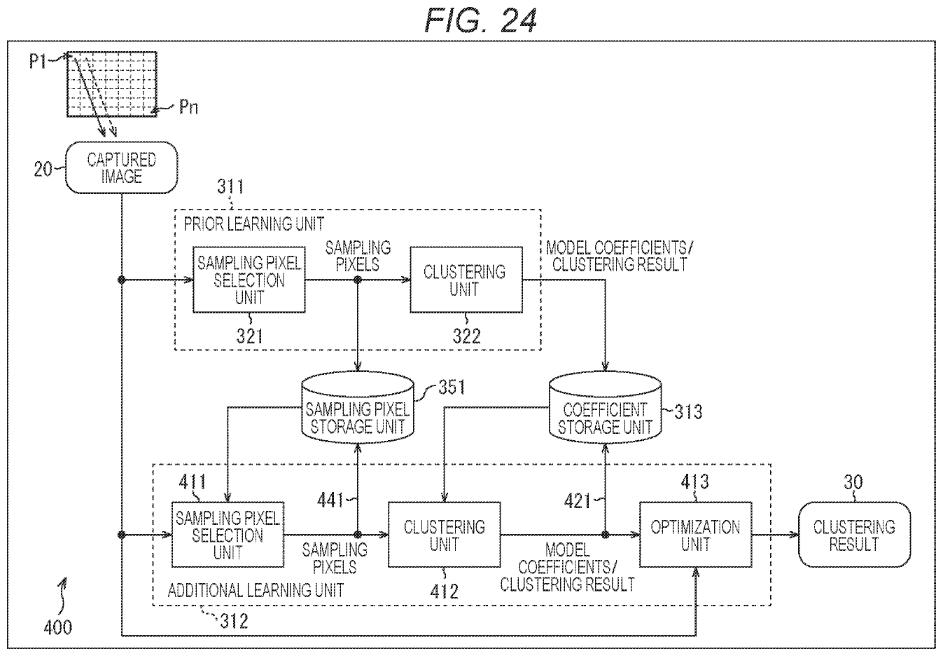

FIG. 24 is a block diagram illustrating a main configuration example of the image processing apparatus 400 in this case. As illustrated in FIG. 24, similar to the case of the image processing apparatus 300 in FIG. 19, the image processing apparatus 400 in this case includes a sampling pixel storage unit 351 in addition to the components in the example in FIG. 21.

In this case, the sampling pixel selection unit 321 of the prior learning unit 311 supplies the selected wide area sampling pixels to the clustering unit 322, and supplies the selected wide area sampling pixels to the sampling pixel storage unit 351, too.

Similar to the case in FIG. 19, the sampling pixel storage unit 351 includes a storage medium, and performs processing related to storage of sampling pixels. For example, the sampling pixel storage unit 351 obtains the wide area sampling pixels supplied from (the sampling pixel selection unit 321 of) the prior learning unit 311, and stores the wide area sampling pixels in (the storage area of) the storage medium of the sampling pixel storage unit 351.

Furthermore, the sampling pixel storage unit 351 supplies the wide area sampling pixels stored in (the storage area of) the storage medium of the sampling pixel storage unit 351 to the sampling pixel selection unit 411 on the basis of, for example, a request of the sampling pixel selection unit 411.

In this case, the sampling pixel selection unit 411 obtains the wide area sampling pixels stored in the sampling pixel storage unit 351. The sampling pixel selection unit 411 selects dense local sampling pixels from pixels other than these wide area sampling pixels in a processing target local area (frame image), and supplies the dense local sampling pixels to the clustering unit 412. By so doing, the clustering unit 412 can suppress an increase in redundancy of clustering, and further suppress a decrease in robustness of image clustering.

Note that, in a case where the additional learning unit 312 performs sequential learning, the sampling pixel selection unit 411 of the additional learning unit 312 supplies the selected local sampling pixels to the clustering unit 412, and supplies the selected local sampling pixels to the sampling pixel storage unit 351, too.

In this case, the sampling pixel storage unit 351 obtains the local sampling pixels supplied from (the sampling pixel selection unit 411 of) this additional learning unit 312, and stores the information in (the storage area of) the storage medium of the sampling pixel storage unit 351. Furthermore, the sampling pixel storage unit 351 supplies the wide area sampling pixels and the previous local sampling pixels stored in (the storage area of) the storage medium of the sampling pixel storage unit 351 to the sampling pixel selection unit 411 on the basis of, for example, a request of the sampling pixel selection unit 411.

Then, the sampling pixel selection unit 411 obtains these wide area sampling pixels and previous local sampling pixels from the sampling pixel storage unit 351. The sampling pixel selection unit 411 selects dense local sampling pixels from pixels other than these wide area sampling pixels and previous local sampling pixels in a processing target local area (frame image), and supplies the dense local sampling pixels to the clustering unit 412. By so doing, the clustering unit 412 can suppress an increase in redundancy of clustering, and further suppress a decrease in robustness of image clustering.

In other words, in a case where the above-described sequential learning is not performed as the additional learning, it is possible to omit supply (i.e., an arrow 441 in FIG. 24) of the local sampling pixels to the sampling pixel storage unit 351.

<Flow of Clustering Processing>

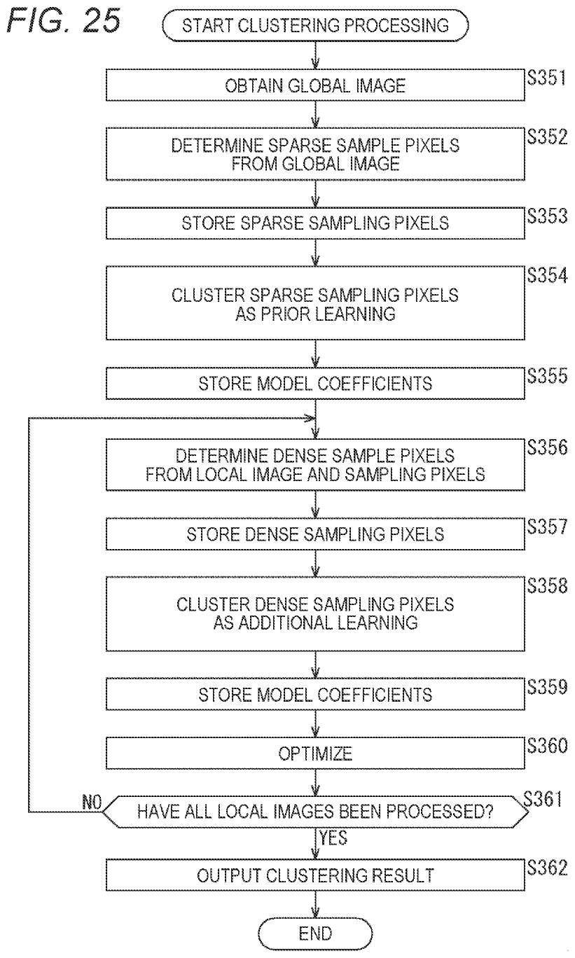

An example of a flow of the clustering processing executed by the image processing apparatus 400 in this case will be described with reference to a flowchart of FIG. 25. When the clustering processing is started, each processing in step S351 and step S352 is executed similar to each processing in step S301 and step S302 (FIG. 23).

In step S353, the sampling pixel storage unit 351 stores the sparse wide area sampling pixels determined in step S352.

When the processing in step S353 ends, each processing in step S354 and step S355 is executed similar to each processing in step S303 and step S304 (FIG. 23).

In step S356, the sampling pixel selection unit 411 of the additional learning unit 312 obtains a processing target local image from a local image group included in the global image obtained in step S351. Furthermore, the sampling pixel selection unit 411 selects dense local sampling pixels from pixels other than the wide area sampling pixels and the previous local sampling pixels in this processing target local image.

In step S357, the sampling pixel storage unit 351 stores the dense local sampling pixels (current local sampling pixels) determined in step S356.

When step S357 ends, each processing in step S358 to step S360 is executed similar to each processing in step S306 to step S308 (FIG. 23).

In step S361, the additional learning unit 312 determines whether or not the additional learning has been performed on all local images. In a case where it is determined that there is an unprocessed local image, the processing returns to step S356 to execute subsequent processing with respect to a next local image as a processing target. That is, each processing in step S356 to step S361 is executed for each local image. In a case where it is determined in step S361 that all the local images have been processed, the processing proceeds to step S362.

In step S362, the optimization unit 413 outputs the clustering result 30 optimized as described above. When the processing in step S362 ends, the clustering processing ends.

By executing each processing as described above, the image processing apparatus 400 can suppress an increase in a processing time while suppressing a decrease in robustness of image clustering.

In other words, note that, in a case where sequential learning is not performed as additional learning, it is possible to omit the processing in step S355 and step S359. Furthermore, in step S356, the sampling pixel selection unit 411 selects sampling pixels by using the wide area sampling pixels stored in the sampling pixel storage unit 351. Furthermore, in step S358, the clustering unit 412 performs the additional learning by using the information stored in the coefficient storage unit 313 and obtained by the prior learning.

<Other Components>

Note that the prior learning unit 311 may be a component of another apparatus in the image processing apparatus 400 in FIG. 21. That is, the image processing apparatus 400 may include the additional learning unit 312 and the coefficient storage unit 313. In this case, the coefficient storage unit 313 obtains and stores sparse information (model coefficients of prior learning, a clustering result, or the like) obtained by the prior learning unit 311 of) the another apparatus. Furthermore, the additional learning unit 312 performs local clustering on dense local sampling pixels by using the sparse information stored in the coefficient storage unit 313 and obtained by (the prior learning unit 311 of) the another apparatus.

Furthermore, the prior learning unit 311 and the coefficient storage unit 313 may be components of another apparatus in the image processing apparatus 400 in FIG. 21. That is, the image processing apparatus 400 may include the additional learning unit 312. In this case, the additional learning unit 312 performs local clustering on dense local sampling pixels by using the sparse information stored in (the coefficient storage unit 313) of the another apparatus and obtained by (the prior learning unit 311 of) the another apparatus.

In both of the cases, similar to the case in FIG. 21, the image processing apparatus 400 can suppress an increase in a processing time while suppressing a decrease in robustness of image clustering.

Furthermore, the prior learning unit 311 may be a component of another apparatus in the image processing apparatus 400 in FIG. 24. That is, the image processing apparatus 400 may include the additional learning unit 312, the coefficient storage unit 313, and the sampling pixel storage unit 351. In this case, the coefficient storage unit 313 obtains and stores sparse information (model coefficients of prior learning, a clustering result, or the like) obtained by the prior learning unit 311 of) the another apparatus. Furthermore, the sampling pixel storage unit 351 obtains and stores sparse wide area sampling pixels selected by (the prior learning unit 311 of) the another apparatus. Furthermore, the additional learning unit 312 selects dense local sampling pixels on the basis of the sparse wide area sampling pixels stored in the sampling pixel storage unit 351 and selected by (the prior learning unit 311 of) the another apparatus, and performs local clustering on these selected dense local sampling pixels by using the sparse information stored in the coefficient storage unit 313 and obtained by (the prior learning unit 311 of) the another apparatus.

Furthermore, the prior learning unit 311 and the coefficient storage unit 313 may be components of another apparatus in the image processing apparatus 400 in FIG. 24. That is, the image processing apparatus 400 may include the additional learning unit 312 and the sampling pixel storage unit 351. In this case, the sampling pixel storage unit 351 obtains and stores wide area sampling pixels selected by (the prior learning unit 311 of) the another apparatus. Furthermore, the additional learning unit 312 selects dense local sampling pixels on the basis of the sparse wide area sampling pixels stored in the sampling pixel storage unit 351 and selected by (the prior learning unit 311 of) the another apparatus, and performs local clustering on these selected dense local sampling pixels by using the sparse information stored in (the coefficient storage unit 313 of) of the another apparatus and obtained by (the prior learning unit 311 of) the another apparatus.

Furthermore, the prior learning unit 311 and the sampling pixel storage unit 351 may be components of another apparatus in the image processing apparatus 400 in FIG. 24. That is, the image processing apparatus 400 may include the additional learning unit 312 and the coefficient storage unit 313. In this case, the coefficient storage unit 313 obtains and stores information (model coefficients of prior learning, a clustering result, or the like) obtained by (the prior learning unit 311 of) the another apparatus. Furthermore, the additional learning unit 312 selects dense local sampling pixels on the basis of the sparse wide area sampling pixels stored in (the sampling pixel storage unit 351 of) the another apparatus and selected by (the prior learning unit 311 of) the another apparatus, and performs local clustering on these selected dense local sampling pixels by using the sparse information stored in the coefficient storage unit 313 and obtained by (the prior learning unit 311 of) the another apparatus.

Furthermore, the prior learning unit 311, the coefficient storage unit 313, and the sampling pixel storage unit 351 may be components of another apparatus in the image processing apparatus 400 in FIG. 24. That is, the image processing apparatus 400 may include the additional learning unit 312. In this case, the additional learning unit 312 selects dense local sampling pixels on the basis of the sparse wide area sampling pixels stored in (the sampling pixel storage unit 351 of) the another apparatus and selected by (the prior learning unit 311 of) the another apparatus, and performs local clustering on these selected dense local sampling pixels by using the sparse information stored in (the coefficient storage unit 313 of) of the another apparatus and obtained by (the prior learning unit 311 of) the another apparatus.

In both of the cases, similar to the case in FIG. 24, the image processing apparatus 400 can suppress an increase in a processing time while suppressing a decrease in robustness of image clustering.

Naturally, in each of these cases, the additional learning unit 312 can perform the above-described sequential learning as the additional learning similar to the cases in FIGS. 21 and 24.

Furthermore, the image processing apparatus 400 may select the local sampling pixels by using at least one or more of field information, stitching information, and flat area information described in the first embodiment. By doing so, it is possible to obtain an effect in a case where each information is used for the additional learning. Naturally, the image processing apparatus 400 may select the sampling pixels by using one or more of these pieces of information and, in addition, information other than the above-described information.

Note that, although the present embodiment has described the case where the captured image 20 is a stitching image, the present embodiment is not limited to this, and the captured image 20 may be a moving image including a plurality of frame images, may be a file (captured image group) obtained by integrating a plurality of captured images into one, or may be one captured image. Naturally, the captured image 20 may be an image other than a captured image (e.g., a CG image or the like). Furthermore, this captured image 20 may be an image of a wavelength range of visible light (RGB), or may be an image obtained by imaging a wavelength range of invisible light such as near-infrared light. Furthermore, the captured image 20 may be both of these images.

Furthermore, a wide area (global area) may not be the entire captured image 20, or a local area (local area) may not be captured images corresponding to one frame. The local area may be an area of the wide area that is narrower than the wide area. As long as this applies, each of the wide area and the local area may be any area in the captured image 20.

### 4. Fourth Embodiment

<Application to Vegetation Area Analysis>

An image processing apparatus (an image processing apparatus 100, an image processing apparatus 300, or an image processing apparatus 400) described above in the first embodiment to the third embodiment can be used to, for example, analyze a vegetation area.

<Image Processing Apparatus>

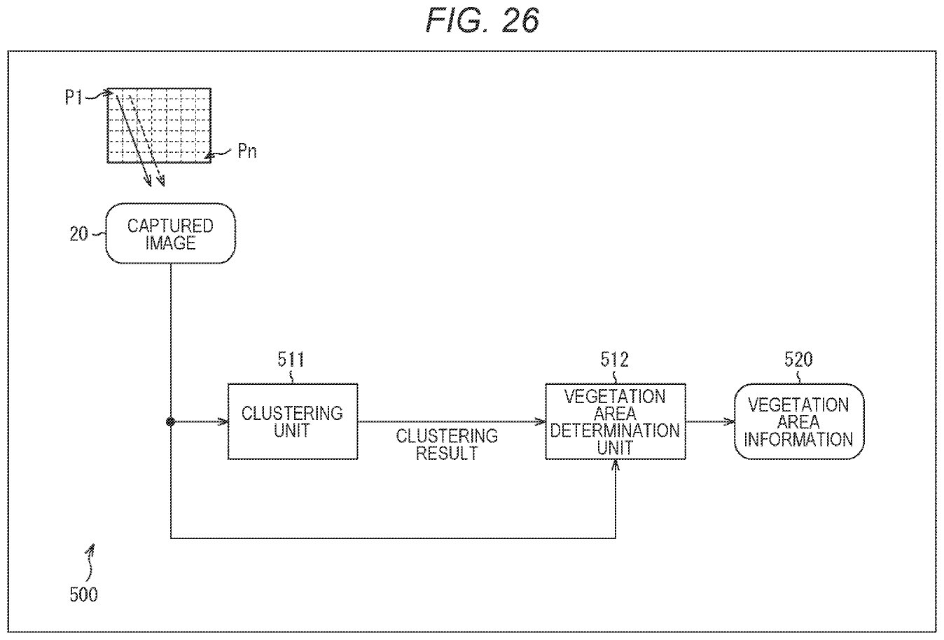

An image processing apparatus 500 illustrated in FIG. 26 is a diagram illustrating an example of an embodiment of an image processing apparatus to which the present technology is applied. This image processing apparatus 500 is an apparatus that analyzes a vegetation area, and, for example, receives as an input a captured image 20 obtained by imaging a field or the like, analyzes a vegetation area by using image clustering for this captured image 20, and outputs vegetation area information 520 that is an analysis result of the analysis.

Similar to the case of each of the above-described embodiments, the captured image 20 may be, for example, a stitching image obtained by stitching a plurality of captured images (P1 to Pn). Furthermore, the captured image 20 may be a moving image including a plurality of frame images. Furthermore, the captured image 20 may be a file (captured image group) obtained by integrating a plurality of captured images into one, or may be one captured image. Furthermore, this captured image 20 may be an image of a wavelength range of visible light (RGB), or may be an image obtained by imaging a wavelength range of invisible light such as near-infrared light. Furthermore, the captured image 20 may be both of these images.

Note that FIG. 26 illustrates main elements such as processing units and data flows, and the elements illustrated in FIG. 26 are not necessarily all. That is, in this image processing apparatus 500, there may be a processing unit that is not illustrated as a block in FIG. 26, or there may be processing or a data flow that is not illustrated as an arrow or the like in FIG. 26.

As illustrated in FIG. 26, the image processing apparatus 500 includes a clustering unit 511 and a vegetation area determination unit 512. The clustering unit 511 performs clustering on the captured image 20, and derives a dense clustering result. The above-described image processing apparatus can be applied to this clustering unit 511. That is, the clustering unit 511 employs a configuration similar to that of one of the above-described image processing apparatuses, and derives a clustering result from the captured image 20 by performing similar processing (clustering). The clustering unit 511 supplies this clustering result to the vegetation area determination unit 512.

The vegetation area determination unit 512 performs processing related to determination of a vegetation area. For example, the vegetation area determination unit 512 obtains the clustering result supplied from the clustering unit 511. Furthermore, the vegetation area determination unit 512 obtains the captured image 20. The vegetation area determination unit 512 determines the vegetation area by using these pieces of information, and outputs the vegetation area information 520 that is an analysis result of the determination. By so doing, the image processing apparatus 500 can generate the analysis result of the vegetation area at a higher speed while suppressing a decrease in robustness.

<Flow of Clustering Processing>

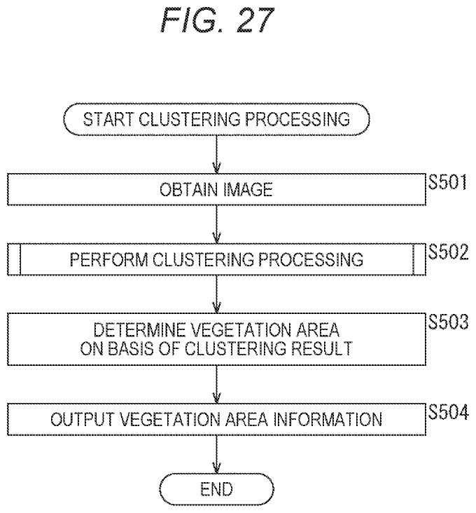

An example of a flow of the clustering processing in this case will be described with reference to a flowchart of FIG. 27. When the clustering processing is started, the clustering unit 511 obtains the captured image 20 in step S501.

In step S502, the clustering unit 511 performs the clustering processing, and obtains a dense clustering result. The above-described clustering processing can be applied to this clustering process. That is, the clustering unit 511 derives the dense clustering result by performing the clustering processing according to a flow similar to each one of the above-described flowcharts.

In step S503, the vegetation area determination unit 512 determines a vegetation area on the basis of the clustering result obtained in step S502, and obtains the vegetation area information 520.

In step S504, the vegetation area determination unit 512 outputs the vegetation area information 520 obtained by the processing in step S503. When the processing in step S504 ends, the clustering processing ends.

By executing each processing as described above, the image processing apparatus 500 can obtain a more accurate clustering result. Consequently, the image processing apparatus 500 can generate the vegetation area information 520 at a higher speed while suppressing a decrease in robustness.

### 5. Fifth Embodiment

<Application to Medical Device>

The present technology described above in the first embodiment to the third embodiment is not limited to the above-described vegetation area analysis, and can be applied to an arbitrary technology in an arbitrary field. For example, the present technology can be used for a medical device.

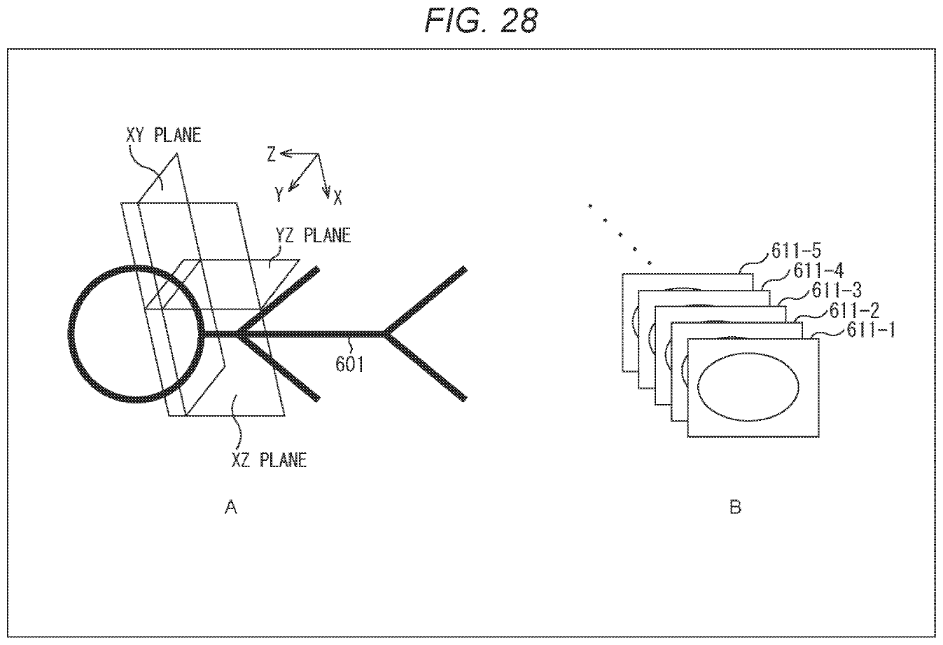

For example, a computed tomography (CT) inspection apparatus irradiates a human body with X-rays while rotating, collects transmitted X-ray intensities by a detector, analyzes and calculates obtained data by a computer, and creates various images. As illustrated in, for example, A of FIG. 28, the CT inspection apparatus can obtain a tomographic image of an arbitrary position and direction such as an XY plane, a YZ plane, and an XZ plane by irradiating a patient 601 with X-rays. For example, a plurality of CT images 611 is obtained as a CT image 611-1 to a CT image 611-5 illustrated in B of FIG. 28. The present technology may be applied to clustering of a plurality of CT images 611 obtained by such CT inspection.

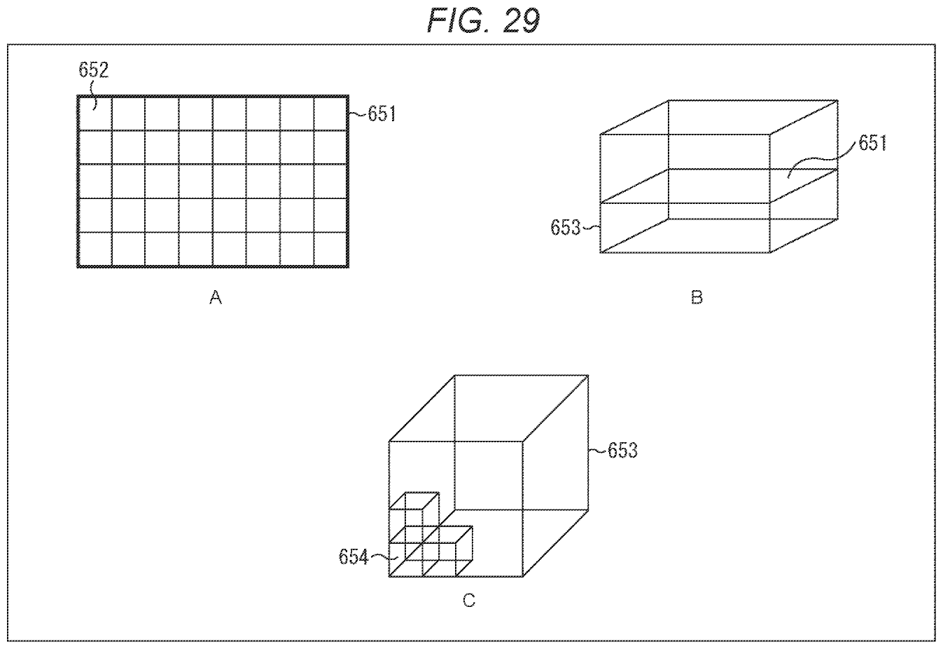

In this case, as in, for example, A of FIG. 29, one entire CT image 651 (CT Slice) may be set as a wide area (global area), for example, a predetermined partial area 652 of this CT image 651 such as a block may be set as a local area (local area), and this clustering may be performed by applying the above-described present technology. That is, in this case, both the wide area and the local area are two-dimensional planes, and each CT image is clustered one by one. In this case, it is possible to perform processing similar to the case of a captured image of a field described above.

In a case where, for example, the method described in the third embodiment is applied, wide area clustering (prior learning) is performed on sparse wide area sampling pixels selected from the entire CT image 651, local clustering (additional learning) is performed on dense local sampling pixels in each block by using the obtained sparse information (model coefficients of the prior learning, a clustering result, or the like) as an initial value, and a dense clustering result is derived.

Furthermore, in a case where, for example, the method described in the second embodiment is applied, wide area clustering (prior learning) is performed on sparse wide area sampling pixels selected from the entire CT image 651, local clustering (additional learning) is performed on sparse local sampling pixels in each block by using the obtained sparse information (model coefficients of the prior learning, a clustering result, or the like) as an initial value, the obtained sparse information (model coefficients of the additional learning, a clustering result, or the like) is interpolated by filtering that uses a two-dimensional image as a guide, and a dense clustering result is derived.

In this case, filtering performs two-dimensional processing of propagating colors of adjacent pixels on the two-dimensional plane (that is, on the same CT image). A processing target pixel xᵢ is derived from a peripheral pixel xⱼ on the same CT image by using, for example, following equation (1). Note that W_{i, j} is a weight coefficient, and is derived as in following equation (2).

$$minimize \text{?} \qquad ( 1 )$$

$$\text{?} \qquad ( 2 )$$

$$\text{?} \text{indicates text missing or illegible when filed}$$

Furthermore, in a case where, for example, the method described in the first embodiment is applied, sparse sampling pixels selected from the entire CT image 651 are clustered, the obtained sparse information (model coefficients of learning, a clustering result, or the like) is interpolated by filtering that uses a two-dimensional image as a guide, and a dense clustering result is derived.

In this case, filtering performs two-dimensional processing of propagating colors of adjacent pixels on the two-dimensional plane (that is, on the same CT image). The processing target pixel xᵢ is derived from the surrounding pixel xⱼ on the same CT image by using, for example, above-described equation (1). Note that W_{i, j} is a weight coefficient, and is derived as in above-described equation (2).

Furthermore, as illustrated in, for example, B of FIG. 29, the CT image 651 (CT Slice) may be set as a local area (local area), a CT volume 653 (CT volume) that is a three-dimensional area including a plurality of CT images 651 may be set as a wide area (global area), and this clustering may be performed by applying the above-described present technology. That is, in this case, the wide area is set as a set of two-dimensional planes (three-dimensional area), a local area is the two-dimensional plane, and the CT volume is collectively clustered.

In a case where, for example, the method described in the third embodiment is applied, wide area clustering (prior learning) is performed on sparse wide area sampling pixels selected from the CT volume 653 (all CT images 651), local clustering (additional learning) is performed on dense local sampling pixels in each CT image 651 by using the obtained sparse information (model coefficients of the prior learning, a clustering result, or the like) as an initial value, and a dense clustering result is derived.

Furthermore, in a case where, for example, the method described in the second embodiment is applied, wide area clustering (prior learning) is performed on sparse wide area sampling pixels selected from the CT volume 653 (all CT images 651), local clustering (additional learning) is performed on sparse local sampling pixels in each CT image 651 by using the obtained sparse information (model coefficients of the prior learning, a clustering result, or the like) as an initial value, the obtained sparse information (model coefficients of the additional learning, a clustering result, or the like) is interpolated by filtering that uses a two-dimensional image as a guide, and a dense clustering result is derived.

In this case, filtering performs three-dimensional processing of propagating colors of adjacent pixels on a three-dimensional space. That is, in this case, it is possible to not only propagate colors of adjacent pixels on the same CT image, but also propagate colors of adjacent pixels on adjacent CT images. The processing target pixel xᵢ is derived from the surrounding pixel xⱼ on the same CT image or an adjacent CT image by using, for example, above-described equation (1). Note that the weighting coefficient W_{i, j} in this case is derived as in following expression (3).

$$\text{?} \qquad ( 3 )$$

$$\text{?} \text{indicates text missing or illegible when filed}$$

Furthermore, in a case where, for example, the method described in the first embodiment is applied, sparse sampling pixels selected from the CT volume 653 (all CT images 651) are clustered, the obtained sparse information (model coefficients of learning, a clustering result, or the like) is interpolated by filtering that uses a two-dimensional image as a guide, and a dense clustering result is derived.

In this case, the filtering performs the above-described three-dimensional processing. The processing target pixel xᵢ is derived from the surrounding pixel xⱼ on the same CT image by using, for example, above-described equation (1). Note that W_{i, j} is a weight coefficient, and is derived as in above-described equation (3).

Furthermore, as illustrated in, for example, C of FIG. 29, the CT volume 653 is set as a wide area (global area), a voxel 654 (voxel) that is a three-dimensional area of a predetermined size obtained by dividing this CT volume 653 is set as a local area (local area), and this clustering may be performed by applying the above-described present technology. That is, in this case, both the wide area and the local area are three-dimensional areas, and the CT volume is collectively clustered.

In a case where, for example, the method described in the third embodiment is applied, wide area clustering (prior learning) is performed on sparse wide area sampling pixels selected from the CT volume 653 (all CT images 651), local clustering (additional learning) is performed on dense local sampling pixels in each voxel 654 by using the obtained sparse information (model coefficients of the prior learning, a clustering result, or the like) as an initial value, and a dense clustering result is derived.

Furthermore, in a case where, for example, the method described in the second embodiment is applied, wide area clustering (prior learning) is performed on sparse wide area sampling pixels selected from the CT volume 653 (all CT images 651), local clustering (additional learning) is performed on sparse local sampling pixels in each voxel 654 by using the obtained sparse information (model coefficients of the prior learning, a clustering result, or the like) as an initial value, the obtained sparse information (model coefficients of the additional learning, a clustering result, or the like) is interpolated by filtering that uses 3D data as a guide, and a dense clustering result is derived.

In this case, filtering performs three-dimensional processing of propagating colors of adjacent pixels on a three-dimensional space. That is, in this case, the color of the adjacent pixel in the three-dimensional space is propagated. The processing target pixel xᵢ is derived from the surrounding pixel xⱼ on the same CT image or an adjacent CT image by using, for example, above-described equation (1). Note that the weighting coefficient W_{i, j} in this case is derived as in above-described expression (3).

Furthermore, in a case where, for example, the method described in the first embodiment is applied, sparse sampling pixels selected from the CT volume 653 (all CT images 651) are clustered, the obtained sparse information (model coefficients of the additional learning, a clustering result, or the like) is interpolated by filtering that uses 3D data as a guide, and a dense clustering result is derived.

In this case, the filtering performs the above-described three-dimensional processing. The processing target pixel xᵢ is derived from the surrounding pixel xⱼ on the same CT image by using, for example, above-described equation (1). Note that W_{i, j} is a weight coefficient, and is derived as in above-described equation (3).

In a case of CT images that make up the CT volume, a correlation of an image structure between images is generally high, and therefore even filtering of three-dimensional processing can obtain a more accurate clustering result similar to the case of two-dimensional processing. Therefore, even in the case where the present technology is applied to the described above medical device, it is possible to suppress an increase in a processing time while suppressing a decrease in robustness of image clustering.

<Image Processing Apparatus>

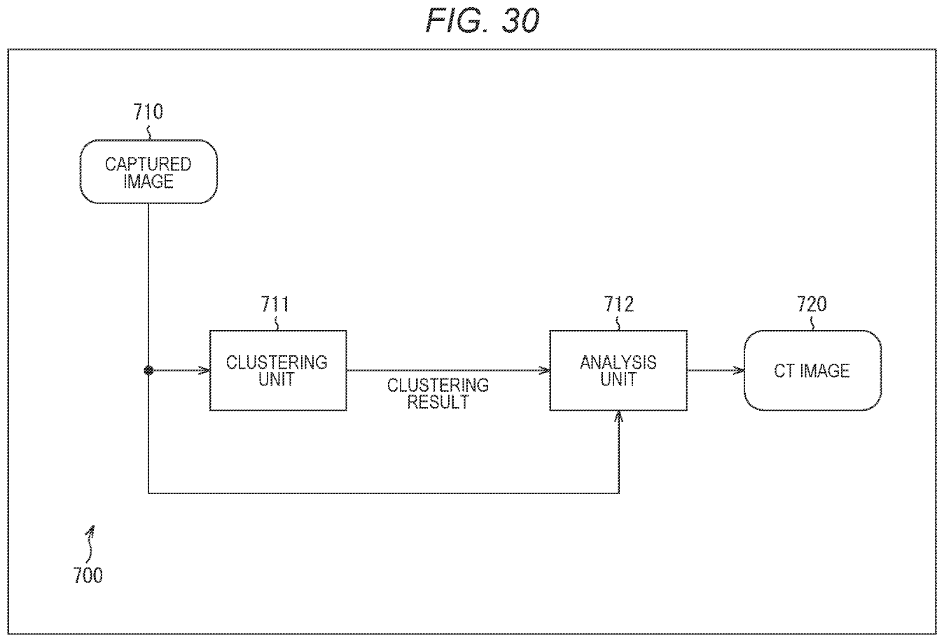

FIG. 30 illustrates a main configuration example of the image processing apparatus in this case. An image processing apparatus 700 illustrated in FIG. 30 is an apparatus that clusters CT images (CT volumes), receives a captured image 710 that is a CT image (CT volume) as an input, clusters this captured image 710, and outputs the clustered CT image 720 as a clustering result of this clustering.

Note that FIG. 30 illustrates main elements such as processing units and data flows, and the elements illustrated in FIG. 30 are not necessarily all. That is, in this image processing apparatus 700, there may be a processing unit that is not illustrated as a block in FIG. 30, or there may be processing or a data flow that is not illustrated as an arrow or the like in FIG. 30.

As illustrated in FIG. 30, the image processing apparatus 700 includes a clustering unit 711 and an analysis unit 712. The clustering unit 711 clusters the captured image 710, and derives a dense clustering result. The above-described image processing apparatus can be applied to this clustering unit 711. That is, the clustering unit 711 employs a configuration similar to that of each one of the above-described image processing apparatuses, and derives a clustering result from the captured image 710 by performing similar processing (clustering). The clustering unit 711 supplies this clustering result to the analysis unit 712.

The analysis unit 712 performs processing related to image analysis on the basis of the clustering result. For example, the analysis unit 712 obtains the clustering result supplied from the clustering unit 711. Furthermore, the analysis unit 712 obtains the captured image 710. The analysis unit 712 analyzes a structure of a human body that is a subject or the like in the captured image 710 on the basis of this clustering result, and images the structure. The analysis unit 712 outputs the generated CT image 720 as an analysis result. By so doing, the image processing apparatus 700 can generate the CT image 720 at a higher speed while suppressing a decrease robustness.

<Flow of Clustering Processing>

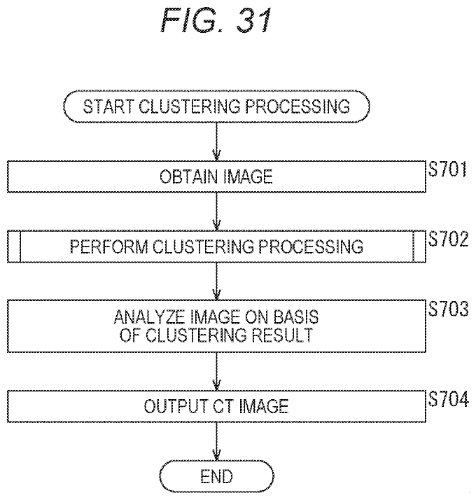

An example of a flow of the clustering processing in this case will be described with reference to a flowchart of FIG. 31. When the clustering processing is started, the clustering unit 711 obtains the captured image 710 in step S701.

In step S702, the clustering unit 711 performs the clustering processing, and obtains a dense clustering result. The above-described clustering processing can be applied to this clustering process. That is, the clustering unit 711 derives the dense clustering result by performing the clustering processing according to a flow similar to each one of the above-described flowcharts.

In step S703, the analysis unit 712 analyzes an image on the basis of the clustering result obtained in step S702.

In step S704, the analysis unit 712 outputs the CT image 720 as an analysis result obtained by the processing in step S703. When the processing in step S704 ends, the clustering processing ends.

By executing each processing as described above, the image processing apparatus 700 can obtain a more accurate clustering result. Consequently, the image processing apparatus 700 can generate the CT image 720 at a higher speed while suppressing a decrease robustness.

### 6. Supplementary Note

<Computer>

The above-described series of processing can be executed by hardware or can be executed by software. In a case where the series of processing is executed by software, a program that configures this software is installed to a computer. Here, the computer includes, for example, a computer incorporated in dedicated hardware, and a general-purpose personal computer that can execute various functions by installing various programs.

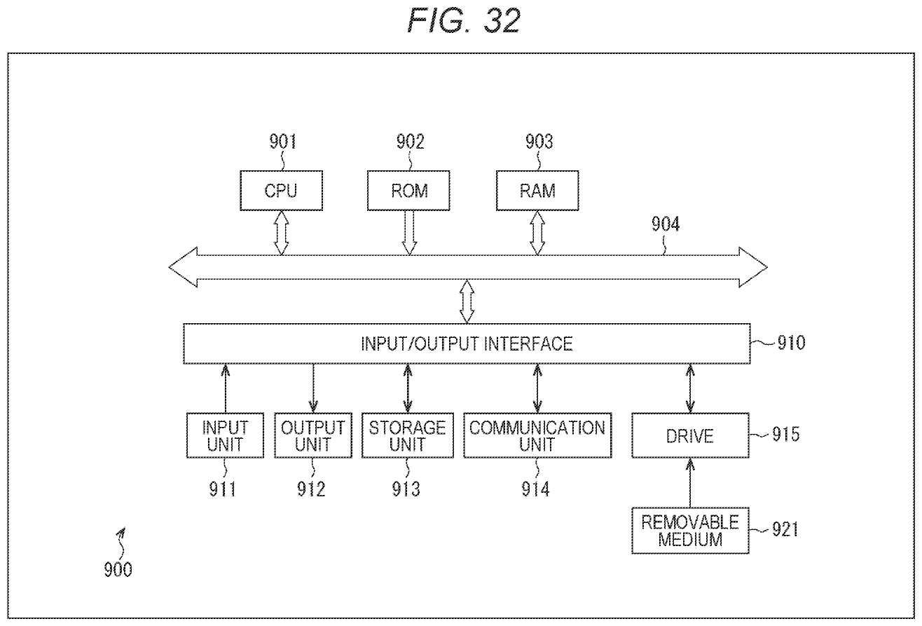

FIG. 32 is a block diagram illustrating a configuration example of hardware of the computer that executes the above-described series of processing by the program.

In a computer 900 illustrated in FIG. 32, a central processing unit (CPU) 901, a read only memory (ROM) 902, and a random access memory (RAM) 903 are mutually connected via a bus 904.

The bus 904 is further connected with an input/output interface 910, too. The input/output interface 910 is connected with an input unit 911, an output unit 912, a storage unit 913, a communication unit 914, and a drive 915.

The input unit 911 includes, for example, a keyboard, a mouse, a microphone, a touch panel, an input terminal, and the like. The output unit 912 includes, for example, a display, a speaker, an output terminal, and the like. The storage unit 913 includes, for example, a hard disk, a RAM disk, a nonvolatile memory, and the like. The communication unit 914 includes, for example, a network interface and the like. The drive 915 drives a removable medium 921 such as a magnetic disk, an optical disk, a magneto-optical disk, or a semiconductor memory.

In the computer configured as described above, for example, the CPU 901 loads a program stored in the storage unit 913 into the RAM 903 via the input/output interface 910 and the bus 904, executes the program, and thereby performs the above-described series of processing. The RAM 903 also appropriately stores data and the like that are necessary for the CPU 901 to execute various types of processing.

For example, the program executed by the computer can be recorded in the removable medium 921 as a package medium or the like, and applied. In this case, the program can be installed in the storage unit 913 via the input/output interface 910 by attaching the removable medium 921 to the drive 915.

Furthermore, this program can be also provided via a wired or wireless transmission medium such as a local area network, the Internet, or digital satellite broadcasting. In this case, the program can be received by the communication unit 914 and installed in the storage unit 913.

In addition, this program can be installed in the ROM 902 or the storage unit 913 in advance.

<Application Target of Present Technology>

Furthermore, although the image processing apparatus that performs image clustering has been described above as an application example of the present technology, the present technology can be applied to an arbitrary configuration.

For example, the present technology can be applied to various electronic devices such as a transmitter and a receiver (e.g., a television receiver and a mobile phone) for satellite broadcasting, cable broadcasting such as a cable TV, distribution on the Internet, and distribution to a terminal by cellular communication, or an apparatus (e.g., a hard disk recorder and a camera) that records an image in a medium such as an optical disk, a magnetic disk, a flash memory or the like, or plays back an image from these storage media.

Furthermore, for example, the present technology can be implemented as part of components of an apparatus such as a processor (e.g., a video processor) such as a system large scale integration (LSI) or the like, a module (e.g., video module) that uses a plurality of processors or the like, a unit (e.g., video unit) that uses a plurality of modules or the like, or a set (e.g., video set) that is obtained by further adding other functions to the unit.

Furthermore, for example, the present technology can also be applied to a network system, too, including a plurality of apparatuses. For example, the present technology can be implemented as cloud computing shared and processed in cooperation by a plurality of apparatuses via a network. For example, the present technology may be implemented for a cloud service that provides a service related to an image (moving image) to an arbitrary terminal such as a computer, an audio visual (AV) device, a portable information processing terminal, or an Internet of Things (IoT) device.

Note that, in this description, a system means a set of a plurality of components (e.g., apparatuses and modules (parts)), and whether or not all components are in the same housing does not matter. Therefore, each of a plurality of apparatuses housed in separate housings and connected via a network, and one apparatus in which a plurality of modules is housed in one housing is the system.

<Field/Usage to which Present Technology is Applicable>

Systems, apparatuses, processing units, and the like to which the present technology is applied can be used in arbitrary fields such as traffic, medical, crime prevention, agricultural, livestock industry, mining, beauty care, factory, home electric appliances, meteorological, and natural monitoring fields. Furthermore, usages of these systems, apparatuses, and processing units are also arbitrary.

<Others>

The embodiments of the present technology are not limited to the above-described embodiments, and various modifications can be made without departing from the gist of the present technology.

For example, a configuration described as one apparatus (or processing unit) may be divided and configured as a plurality of apparatuses (or processing units). Conversely, the configurations described above as a plurality of apparatuses (or processing units) may be collectively configured as one apparatus (or processing unit). Furthermore, a configuration other than the above-described configuration may be naturally added to the configuration of each apparatus (or each processing unit). Furthermore, as long as the configuration and the operation of the entire system are substantially the same, part of components of a certain apparatus (or processing unit) may be included in the components of another apparatus (or another processing unit).

Furthermore, for example, the above-described program may be executed by an arbitrary apparatus. In this case, this apparatus is only required to have necessary functions (functional blocks or the like), and be able to have obtain necessary information.

Furthermore, for example, each step of one flowchart may be executed by one apparatus, or may be shared and executed by a plurality of apparatuses. Furthermore, in a case where a plurality of processing is included in one step, a plurality of processing may be executed by one apparatus, or may be shared and executed by a plurality of apparatuses. In other words, a plurality of processing included in one step can be also executed as processing of a plurality of steps. Conversely, the processing described as a plurality of steps can be also collectively executed as one step.

Furthermore, according to, for example, a program executed by the computer, processing in steps that describe the program may be executed in chronological order according to the order described in this description, or may be executed in parallel or individually at necessary timing such as a time when invoked or the like. That is, unless a contradiction arises, processing in each step may be executed in an order different from the above-described order. Furthermore, the processing in steps that describe this program may be executed in parallel with processing of another program, or may be executed in combination with the processing of the another program.

Furthermore, for example, a plurality of techniques related to the present technology can be implemented independently alone unless a contradiction arises. Naturally, a plurality of arbitrary present technologies can be also implemented in combination. For example, part or entirety of the present technology described in one of the embodiments can be implemented in combination with part or entirety of the present technology described in other embodiments. Furthermore, part or entirety of the above-described arbitrary present technology can be implemented in combination with other technologies that are not described above.

Note that the present technology can also employ the following configurations.

(1) An image processing apparatus including:

a clustering unit configured to cluster a sparse pixel included in an image; and

an interpolation processing unit configured to interpolate sparse information by image filtering, and thereby derive a dense clustering result, the sparse information being obtained by the clustering of the clustering unit, and the image filtering using an image signal as a guide.

(2) The image processing apparatus according to (1), in which the sparse information is a model coefficient or a clustering result obtained by the clustering.

(3) The image processing apparatus according to (1) or (2), further including a sampling pixel selection unit configured to select a sparse sampling pixel from the image,

in which the clustering unit performs the clustering on the sparse sampling pixel selected by the sampling pixel selection unit.

(4) The image processing apparatus according to (3), in which the sampling pixel selection unit selects the sampling pixel from a portion included in a processing target area of the image on the basis of information regarding the processing target area.

(5) The image processing apparatus according to (3) or (4), in which

the image is a stitching image obtained by stitching a plurality of images, and

the sampling pixel selection unit selects the sampling pixel on the basis of stitching information that is information regarding the plurality of images of the stitching image overlapping each other.

(6) The image processing apparatus according to any one of (3) to (5), in which the sampling pixel selection unit selects the sampling pixel from a flat area of the image on the basis of information regarding the flat area.

(7) The image processing apparatus according to any one of (1) to (6), in which

the clustering unit performs local clustering by using sparse information as the clustering, the local clustering being clustering of a sparse pixel included in a local area of the image, and the sparse information being obtained by wide area clustering that is clustering of a sparse pixel included in a wide area of the image, and

the interpolation processing unit interpolates, by the image filtering, the sparse information obtained by the local clustering, and thereby derives a dense clustering result of the local area.

(8) The image processing apparatus according to (7), in which the sparse information obtained by the wide area clustering is a model coefficient or a clustering result.

(9) The image processing apparatus according to (7) or (8), in which the clustering unit further performs the local clustering on a processing target local area by using the sparse information obtained by the local clustering on one previous processing target local area.

(10) The image processing apparatus according to any one of (7) to (9), further including a sampling pixel selection unit configured to select a sparse sampling pixel from the local area,

in which the clustering unit performs the local clustering on the sparse sampling pixel selected by the sampling pixel selection unit.

(11) The image processing apparatus according to (10), the sampling pixel selection unit selects the sampling pixel from pixels in the local area other than pixels on which the wide area clustering has been performed.

(12) The image processing apparatus according to any one of (7) to (11), further including a wide area clustering unit configured to perform the wide area clustering,

in which the clustering unit performs the local clustering by using information obtained by the wide area clustering performed by the wide area clustering unit.

(13) An image processing method including:

clustering a sparse pixel included in an image; and

interpolating sparse information by image filtering, and thereby deriving a dense clustering result, the sparse information being obtained by the clustering, and the image filtering using an image signal as a guide.

(14) An image processing apparatus including a clustering unit configured to perform local clustering by using information, the local clustering being clustering of a dense pixel included in a local area of an image, and the information being obtained by wide area clustering that is clustering of a sparse pixel included in a wide area of the image.

(15) An image processing method including performing local clustering by using information, the local clustering being clustering of a dense pixel included in a local area of an image, and the information being obtained by wide area clustering that is clustering of a sparse pixel included in a wide area of the image.

### REFERENCE SIGNS LIST

100 Image processing apparatus
111 Sampling pixel selection unit
112 Clustering unit
113 Interpolation processing unit
201 Field area storage unit
231 Stitching information storage unit
261 Flat area storage unit
300 Image processing apparatus
311 Prior learning unit
312 Additional learning unit
313 Coefficient storage unit
321 Sampling pixel selection unit
322 Clustering unit
351 Sampling pixel storage unit
400 Image processing apparatus
411 Sampling pixel selection unit
412 Clustering unit
413 Optimization unit
500 Image processing apparatus
511 Clustering unit
512 Vegetation area determination unit
700 Image processing apparatus
711 Clustering unit
712 Analysis unit
900 Computer

1. An image processing apparatus comprising:
a clustering unit configured to cluster a sparse pixel included in an image; and
an interpolation processing unit configured to interpolate sparse information by image filtering, and thereby derive a dense clustering result, the sparse information being obtained by the clustering of the clustering unit, and the image filtering using an image signal as a guide.

2. The image processing apparatus according to claim 1, wherein the sparse information is a model coefficient or a clustering result obtained by the clustering.

3. The image processing apparatus according to claim 1, further comprising a sampling pixel selection unit configured to select a sparse sampling pixel from the image,
wherein the clustering unit performs the clustering on the sparse sampling pixel selected by the sampling pixel selection unit.

4. The image processing apparatus according to claim 3, wherein the sampling pixel selection unit selects the sampling pixel from a portion included in a processing target area of the image on a basis of information regarding the processing target area.

5. The image processing apparatus according to claim 3, wherein
the image is a stitching image obtained by stitching a plurality of images, and
the sampling pixel selection unit selects the sampling pixel on a basis of stitching information that is information regarding the plurality of images of the stitching image overlapping each other.

6. The image processing apparatus according to claim 3, wherein the sampling pixel selection unit selects the sampling pixel from a flat area of the image on a basis of information regarding the flat area.

7. The image processing apparatus according to claim 1, wherein
the clustering unit performs local clustering by using sparse information as the clustering, the local clustering being clustering of a sparse pixel included in a local area of the image, and the sparse information being obtained by wide area clustering that is clustering of a sparse pixel included in a wide area of the image, and
the interpolation processing unit interpolates, by the image filtering, the sparse information obtained by the local clustering, and thereby derives a dense clustering result of the local area.

8. The image processing apparatus according to claim 7, wherein the sparse information obtained by the wide area clustering is a model coefficient or a clustering result.

9. The image processing apparatus according to claim 7, wherein the clustering unit further performs the local clustering on a processing target local area by using the sparse information obtained by the local clustering on one previous processing target local area.

10. The image processing apparatus according to claim 7, further comprising a sampling pixel selection unit configured to select a sparse sampling pixel from the local area,
wherein the clustering unit performs the local clustering on the sparse sampling pixel selected by the sampling pixel selection unit.

11. The image processing apparatus according to claim 10, wherein the sampling pixel selection unit selects the sampling pixel from pixels of the local area other than pixels on which the wide area clustering has been performed.

12. The image processing apparatus according to claim 7, further comprising a wide area clustering unit configured to perform the wide area clustering,
wherein the clustering unit performs the local clustering by using information obtained by the wide area clustering performed by the wide area clustering unit.

13. An image processing method comprising:
clustering a sparse pixel included in an image; and
interpolating sparse information by image filtering, and thereby deriving a dense clustering result, the sparse information being obtained by the clustering, and the image filtering using an image signal as a guide.

14. An image processing apparatus comprising a clustering unit configured to perform local clustering by using information, the local clustering being clustering of a dense pixel included in a local area of an image, and the information being obtained by wide area clustering that is clustering of a sparse pixel included in a wide area of the image.

15. An image processing method comprising performing local clustering by using information, the local clustering being clustering of a dense pixel included in a local area of an image, and the information being obtained by wide area clustering that is clustering of a sparse pixel included in a wide area of the image.
